(19) United States
(12) Patent Application Publication
(10) Pub. No.: US 2024/0298173 A1
(43) Pub. Date: Sep. 5, 2024

(54) SECURE CONTROL INFORMATION

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Sai Yiu Duncan HO, San Diego, CA (US); Yanjun SUN, San Diego, CA (US); Gaurang NAIK, San Diego, CA (US); Abdel Karim AJAMI, San Diego, CA (US); Jouni Kalevi MALINEN, Tuusula (FI); James Simon CHO, Stateline, NV (US); Guido Robert FREDERIKS, Watsonville, CA (US)

(21) Appl. No.: 18/365,946

(22) Filed: Aug. 4, 2023

Related U.S. Application Data
(60) Provisional application No. 63/487,879, filed on Mar. 1, 2023.
(60) Provisional application No. 63/504,189, filed on May 24, 2023.

(51) Int. Cl. H04W 12/04

(52) U.S. Cl. CPC H04W 12/04

(57) ABSTRACT

This disclosure provides methods, components, devices, and systems for securing frames. In some examples, a frame is transmitted with a field that includes an identifier (ID) of a security key, a packet number (PN), and an integrity check based on one or more portions of the control frame and the security key. A device receiving the frame can verify the frame by calculating another integrity check based on the frame and the identified security key and comparing the calculated integrity check to the received integrity check.

### CROSS-REFERENCE TO RELATED APPLICATIONS

This application claims benefit of and priority to U.S. Provisional Patent Application No. 63/487,879, filed on Mar. 1, 2023, and U.S. Provisional Patent Application No. 63/504,189, filed on May 24, 2023, which are assigned to the assignee hereof and herein incorporated by reference in their entireties as if fully set forth below and for all applicable purposes.

### TECHNICAL FIELD

This disclosure relates generally to wireless communication, and more specifically, to securing frames, especially frames including control information.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs) or user equipments (UEs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, APs and STAs may engage in reliable, e.g., ultra-high reliability (UHR), communications. The UHR communications may rely on transmissions of control information for many purposes, such as for example acknowledgments, network allocation vector (NAV) setting, sounding, triggering, cross link control signaling, etc.

A malicious actor may attack a wireless communication by targeting the frames containing control information. Such attacks can lead to denial of service, power drain at UEs, decrease of reliability of the communications, wastage of radio frequency resources, etc.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device includes a memory comprising instructions; and one or more processors configured to execute the instructions and cause the apparatus to: generate a frame comprising an identifier (ID) of a security key, a packet number (PN), and an integrity check, wherein: the integrity check is based on one or more portions of the frame, and the generation comprises computing the integrity check based at least on the security key; and output, for transmission, the frame.

Another innovative aspect of the subject matter described in this disclosure can be implemented in a wireless communication device. The wireless communication device includes a memory comprising instructions; and one or more processors configured to execute the instructions and cause the apparatus to: obtain a frame comprising an identifier (ID) of a security key, a packet number (PN), and an integrity check; and verify the validity of the frame, based on a comparison of the integrity check and another integrity check based on at least the security key and one or more portions of the frame.

Another innovative aspect of the subject matter described in this disclosure can be implemented in a method for wireless communication. The method includes generating a frame comprising an identifier (ID) of a security key, a packet number (PN), and an integrity check, wherein: the integrity check is based on one or more portions of the frame, and the generation comprises computing the integrity check based at least on the security key; and transmitting the frame.

Another innovative aspect of the subject matter described in this disclosure can be implemented in a method for wireless communication. The method includes obtaining a frame comprising an identifier (ID) of a security key, a packet number (PN), and an integrity check; and responding to the frame, based on a comparison of the integrity check and another integrity check based on at least the security key and one or more portions of the frame.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A illustrates a trigger frame in block form.

FIG. 2B illustrates a set of trigger-based communications.

FIGS. 3A and 3B illustrate example control message integrity check (MIC) fields (CMFs).

FIG. 4 illustrates an example secure trigger frame.

FIG. 5 illustrates an example of incorporating a CMF into user information list fields of a trigger frame.

FIG. 6 shows an example secure null data packet (NDP) announcement frame.

FIG. 7 illustrates an example of incorporating a CMF into STA information list fields of a NDP announcement frame.

FIG. 8 illustrates an example secure M-BA frame.

FIG. 9 illustrates an example of incorporating a CMF into a Per AID TID information field of a secure M-BA frame.

FIG. 10 illustrates an example secure multiple traffic identifier (multi-TID) block acknowledgment request (BAR) frame.

FIG. 11 illustrates an example medium access control (MAC) protocol data unit (PDU), in accordance with certain aspects of the present disclosure.

FIG. 12 illustrates an example algorithm for encrypting data of a MAC PDU (MPDU), according to previously known techniques.

FIG. 13 illustrates an example algorithm for encrypting MAC header fields and protecting those fields for an individually addressed quality of service (QoS) data frame or management frame.

FIG. 14 illustrates an example algorithm for encrypting MAC header fields and protecting those fields for a QoS Null frame, a retried QoS data frame, or a management frame.

FIG. 15 illustrates an example of incorporating a header protection (HDR PRO) field into an MPDU.

FIG. 16 is an example call flow illustrating communications among an AP, a UHR STA, a non-UHR STA, and an attacker device.

FIG. 17 shows a flowchart illustrating an example process performable by a wireless transmitter that supports securing frames.

FIG. 18 shows a flowchart illustrating an example process performable by a wireless receiver that supports securing frames.

FIG. 19 is a block diagram of an example access point (AP) and example wireless stations (STAs), in accordance with certain aspects of the present disclosure.

FIG. 20 shows a block diagram of an example wireless communication device that supports securing frames.

FIG. 21 shows a block diagram of an example wireless communication device that supports securing frames.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to securing frames, especially frames including control information. In some examples, a frame is transmitted with a field that includes an identifier (ID) of a security key, at least a portion of a packet number (PN), and at least a portion of an integrity check computed based on one or more portions of the frame including the control information and the security key. The security key may be an integrity group temporal key (IGTK), a pairwise temporal key (PTK), or a temporal key used for control packets that may be referred to as a control integrity temporal key (CIGTK). Such a CIGTK may be shared between an AP and authenticated STAs during or after authentication. The packet number may be an IGTK packet number or an integrity pairwise temporal key (IPTK) packet number. In some cases, the frame may only contain a portion of a complete PN, e.g., the 2 least significant octets of the complete PN, and the remaining portion of the complete PN may be exchanged between the devices periodically or separately via encrypted management frames. In some cases, the frame may only contain a portion of the computed integrity check, e.g., the 4 least significant octets.

The frame may, in some examples, be a trigger frame, a null data packet (NDP) announcement frame, a multi-station block acknowledgment (M-BA) frame, a compressed BlockAck frame, a block acknowledgment request (BAR) frame, or another type of control frame. In the various frames, the ID, PN, and integrity check may be included in information fields of the frame that include reserved values or in padding of the frame. A receiver receiving such a frame can verify the frame by computing an integrity check for the frame using the security key identified by the ID included in the frame and comparing the computed integrity check with the integrity check included in the frame. In addition, a receiver receiving such a frame can verify that the frame is not a replay of a frame the receiver has already received by checking that the PN of the frame is the expected PN, such as the next PN in sequence.

In certain Wi-Fi communications systems, a MAC header of a MAC PDU (also referred to as an MPDU, a MAC frame, or a packet) is not encrypted, and so the unencrypted MAC header is transmitted with the encrypted data of the MAC PDU. In such cases, some portions of some fields of the MAC header may be protected from alteration by being included in additional authenticated data (AAD) of the MPDU. If an attacker attempts to alter the portions of the fields included in the AAD of a transmitted MPDU or while transmitting a repetition of an MPDU (e.g., an attacking frame), a recipient may detect the changes and reject (e.g., discard) the frame.

Because certain Wi-Fi communication systems do not encrypt the header of an MPDU, the headers of MPDUs transmitted by a STA may be used to track the STA's activity. For example, a STA's participation in a video call via a Wi-Fi network may be trackable, and other activities by the same STA may also be linked to the STA.

Particular aspects of the subject matter described in this disclosure can be implemented to realize one or more of the following potential advantages. In some examples, by verifying a control frame, a UE can avoid wasting power and radio frequency resources when the UE receives an invalid control frame from an attacker. In addition, the described techniques can be used to quickly verify a control frame, allowing devices to quickly respond to the control frames, as opposed to some techniques in which large portions of a frame are encrypted, which can cause a device to spend significant time decrypting those portions of the frame. If an attacker repeats a control frame, the receiver discards the repeat because the packet number does not match the expected packet number. If an attacker changes data in a legitimate control frame, the receiver discards the changed frame because the integrity check the receiver computes does not match the integrity check in the received frame. If an attacker attempts to impersonate the controller and send a frame, the receiver discards the frame because the attacker does not have the same security keys, so the included integrity check will not be match an integrity check computed by the receiver. If an attacker copies a control message integrity check (MIC) field (CMF) from a legitimate frame into another frame, the receiver discards the frame because the packet number is not what is expected at the receiver or because the included integrity check does not match an integrity check computed by the receiver. The techniques described herein also have the advantage of being backwards-compatible, so that devices that are not programmed to use the described techniques can still successfully receive and respond to frames including the ID, PN, and integrity check.

Aspects of the present disclosure provide methods and apparatus for encrypting a MAC header of an MPDU transmitted by a node (e.g., an AP or a STA) and for a receiving node to decrypt the MAC header. By encrypting the header of the MPDU, privacy of a user of a node transmitting or receiving the MAC PDU may be protected.

The teachings herein may be incorporated into (e.g., implemented within or performed by) a variety of wired or wireless apparatuses (e.g., nodes). In some aspects, a wireless node implemented in accordance with the teachings herein may comprise an access point (AP) or an access terminal (AT).

The AP may comprise, be implemented as, or known as a node B (NB), a radio network controller (RNC), an evolved node B (eNB), a base station controller (BSC), a base transceiver station (BTS), a base station (BS), a transceiver function (TF), a radio router, a radio transceiver, a basic service set (BSS), an extended service set (ESS), a radio base station (“RBS”), an integrated access and backhauling (IAB) node (e.g., an IAB donor node, an IAB parent node, and an IAB child node), or some other terminology.

The AT may comprise, be implemented as, or known as a subscriber station, a subscriber unit, a mobile station, a remote station, a remote terminal, a user terminal, a user agent, a user device, a user equipment (UE), a user station, or some other terminology. In some implementations, the AT may comprise a cellular telephone, a cordless telephone, a session initiation protocol (SIP) phone, a wireless local loop (WLL) station, a personal digital assistant (PDA), a handheld device having wireless connection capability, a station (STA), or some other suitable processing device connected to a wireless modem (such as an augmented reality (AR)/virtual reality (VR) console and headset). Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

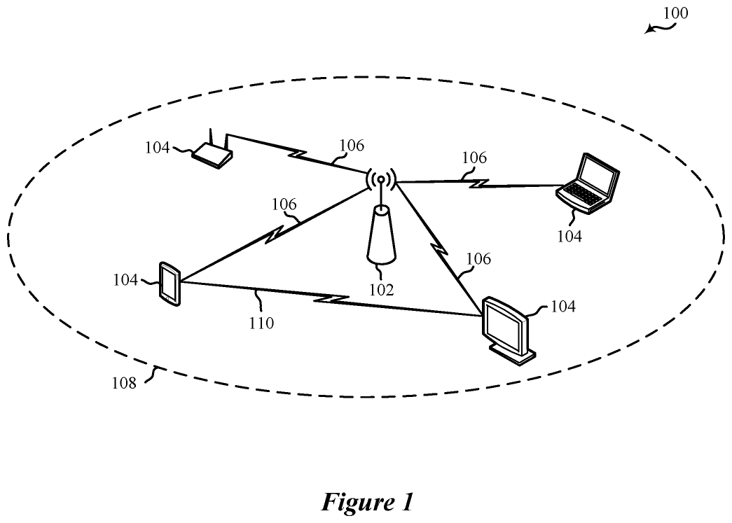

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell that is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone, and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

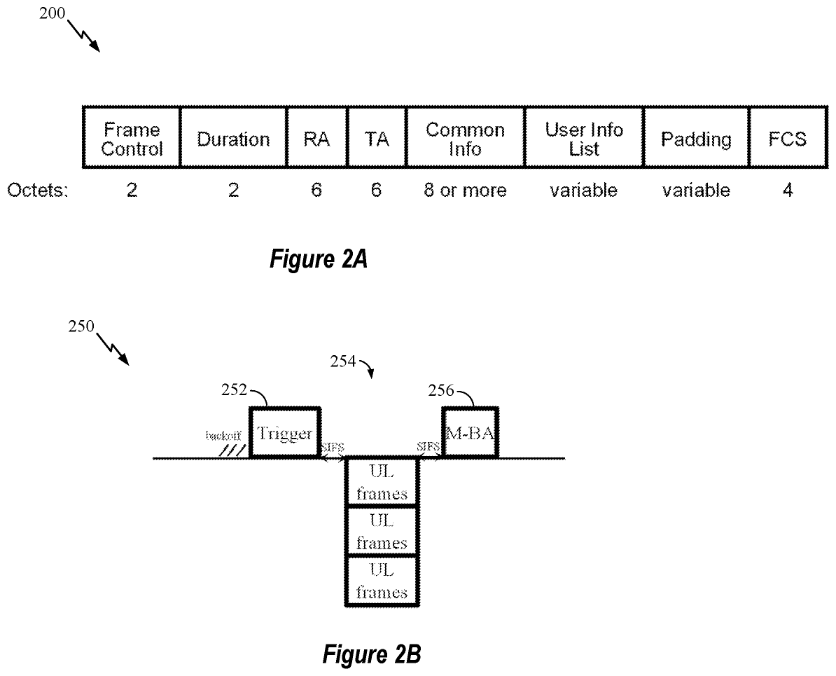

FIG. 2A illustrates a trigger frame 200 in block form, in accordance with aspects of the present disclosure. As illustrated, the trigger frame 200 may include a frame control field, a duration field, a receiver address (RA) field, a transmitter address (TA) field, a common information field, a user information list, padding, and a frame check sequence (FCS) field.

FIG. 2B illustrates a set of trigger-based communications 250, in accordance with aspects of the present disclosure. As illustrated, an AP (such as AP 102, described above with reference to FIG. 1) may transmit a trigger frame 252, which may be an example of the trigger frame 200 described above with reference to FIG. 2A. Upon receiving the trigger frame 252, one or more UEs (such as UEs 104, described above with reference to FIG. 1) may transmit UL frames 254 in response to the trigger frame 252. In response to the UL frames 254, the AP may transmit a multi-station block acknowledgment (M-BA) frame 256 to the UEs. The M-BA frame may indicate successful reception of one or more of the UL frames 254 while also indicating that the AP did not receive one or more other UL frames 254.

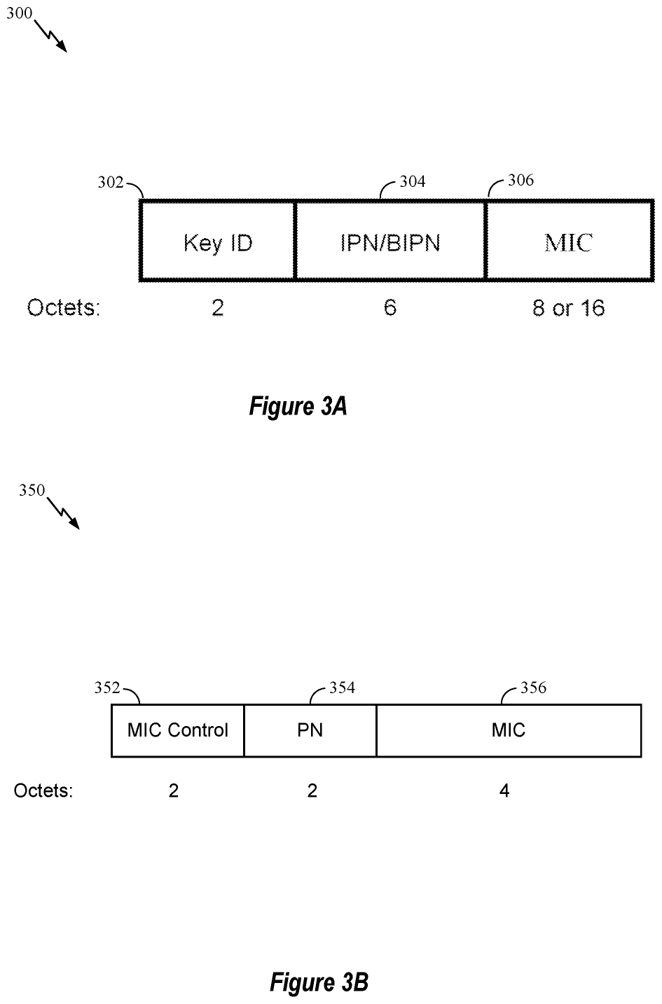

FIG. 3A illustrates an example control message integrity check (MIC) field (CMF) 300, in accordance with aspects of the present disclosure. The example CMF 300 includes a security key ID field 302 that includes two octets, an integrity group temporal key (IGTK) packet number or integrity pairwise temporal key (IPTK) packet number 304 that includes six octets, and a message integrity check (MIC) field 306 (also referred to herein as a message integrity code field) that includes eight or sixteen octets. It may be noted that the example CMF 300 has a structure similar to a management MIC information element (IE) that may be used to protect beacon frames. However, the present disclosure is not limited to the structure illustrated in FIG. 3A and includes CMFs having other structures. For example, the ID described herein may be conveyed in fields smaller than two octets, or as bits that are included in other fields of a frame. In another example, the complete packet number (PN) described herein may be split into a partial packet number (PPN) and a base packet number, and the PN field of the CMFs described herein may convey the PPN instead of the complete packet number. The wireless nodes described herein may exchange the base packet number occasionally (e.g., regularly, in response to a request, or in response to a triggering event) and store the base packet number for use (e.g., in calculations, transmissions, or verifying received packets). In yet another example, the wireless nodes described herein may include only a portion of a MIC in a packet (e.g., in a CMF in a packet). The wireless nodes described herein may transmit four octets of a MIC (e.g., the four least significant octets of the MIC), and a node receiving a packet including four octets of a MIC may compare those four octets to the corresponding four octets of an integrity check calculated based at least on the security key and other portions of the packet.

FIG. 3B illustrates an example CMF 350, according to aspects of the present disclosure. The example CMF 350 includes a MIC Control field 352, a PN field 354, and a MIC field 356. As illustrated, the MIC Control field 352 may include two octets, which may include one or more bits that convey a Key ID and/or other bits indicating a combined length of the MIC control field and the PN field. The PN field 354 may include two octets and may convey a PPN, which may, for example, be the two least significant octets of a packet number. The MIC field 356 may include four octets that convey a portion (e.g., four least significant octets) of a MIC for the packet.

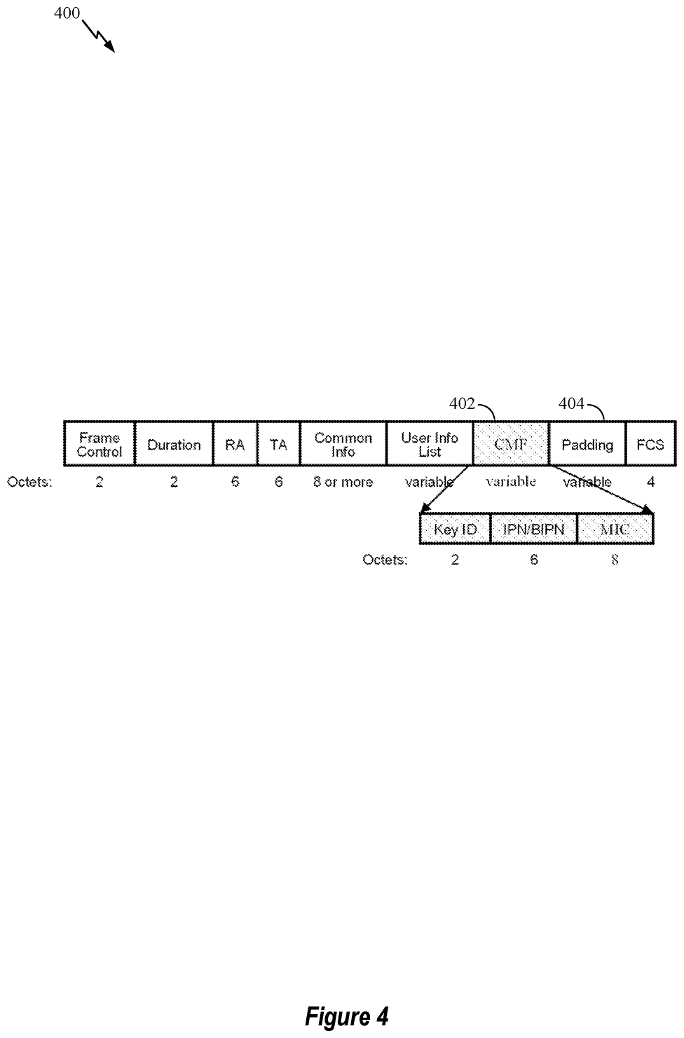

FIG. 4 illustrates an example secure trigger frame 400, in accordance with aspects of the present disclosure. As illustrated, the secure trigger frame 400 includes a CMF 402 after the user information list and may include padding 404 after the CMF. Alternatively, the CMF may be included in the padding of the secure trigger frame 400. The MIC of the CMF may be calculated over all or part of the fields of the MAC header (e.g., Duration, TA, RA, etc.), the trigger frame body, including the common information field, the user information list fields, the security key corresponding to the ID field, and the PN field. UHR STAs that are associated with the AP and unassociated UHR STAs that have access to the IGTK may verify the trigger frame. If those STAs are unable to verify the trigger frame because the computed MIC does not match the MIC in the trigger frame, then the STAs discard the trigger frame and avoid generating trigger-based (TB) PPDUs, thus saving power. Other STAs that are not UHR STAs, such as HE or EHT STAs, may ignore the CMF 402 while processing the remainder of the trigger frame 400. While the illustrated CMF 402 is similar to the CMF 300 shown in FIG. 3A, the present disclosure is not so limited, and a CMF in a secure trigger frame may have other structures, such as the structure of the example CMF 350 illustrated in FIG. 3B.

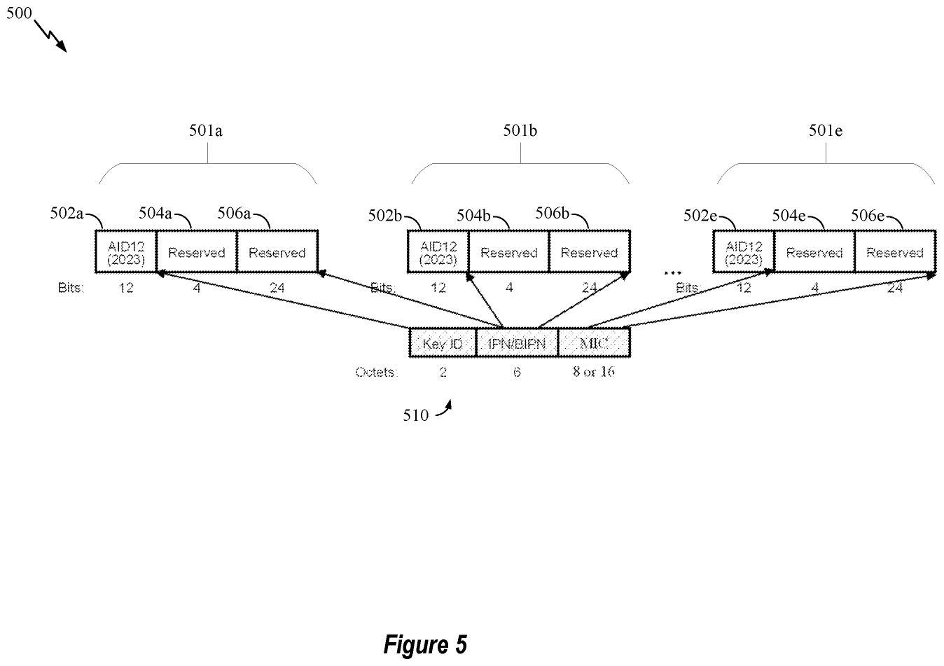

FIG. 5 illustrates an example 500 of incorporating a CMF 510 (which may be an example of CMFs 300 or 350, described above with reference to FIGS. 3A and 3B) into user information list fields 501 of a trigger frame, such as trigger frame 400 (described above with reference to FIG. 4), in accordance with aspects of the present disclosure. Three user information list fields 501a, 501b, and 501e are illustrated, and each user information list field includes five octets. The five octets, of each of the user information list fields, include an association ID field 502 that includes twelve bits, a first field 504 that includes four bits, and a second field 506 that includes twenty-four bits. As illustrated, the bits of the CMF 510 may be included in the first fields 504a, 504b, 504c, etc. and second fields 506a, 506b, 506c, etc. of user information list fields that include an association ID field 502a, 502b, 502c, etc. that is set to a reserved value, such as 2023. When the MIC includes eight octets, then a CMF having the structure of CMF 300 may be included in five user information list fields of five octets each. When the MIC includes sixteen octets, then a CMF having the structure of CMF 300 may be included in seven user information list fields of five octets each.

In aspects of the present disclosure, one or more reserved values of association IDs may indicate presence of a MIC in a field of a secure trigger frame.

According to aspects of the present disclosure, a CMF may be included in a padding field of a trigger frame, after a sequence of sixteen ones in the first two octets of the padding that is used to signal to receivers that padding has begun. The CMF may be included in the next eight, sixteen, twenty-four, or another number of octets of the padding field, and additional bits after the CMF may be considered padding.

According to aspects of the present disclosure, a bit in a trigger frame, such as a protected bit in the frame control field, may be used to indicate the presence of the CMF in the trigger frame.

In aspects of the present disclosure, a bit in a trigger frame, such as a bit in the padding field, may indicate the length (such as sixteen octets or twenty-four octets) of the CMF that is present in the trigger frame.

According to aspects of the present disclosure, an UHR STA may verify a frame based on the CMF and begin processing the frame before the UHR has checked the FCS, because verifying the PN in the CMF may substitute for checking the FCS of the frame.

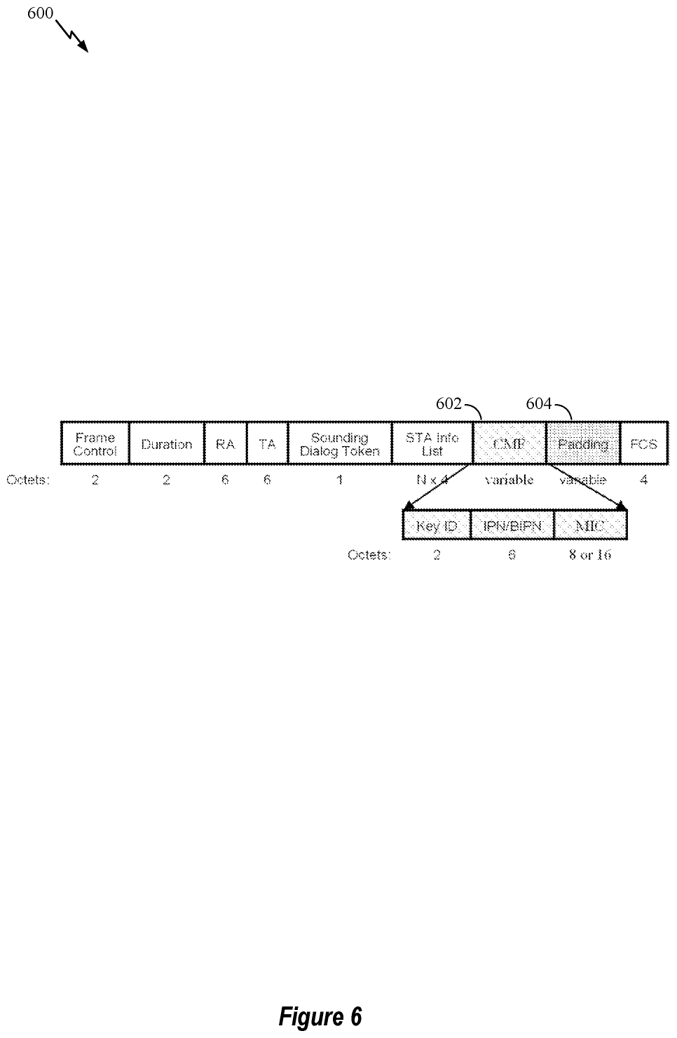

FIG. 6 shows an example secure null data packet (NDP) announcement frame 600, in accordance with aspects of the present disclosure. As illustrated, the secure NDP announcement frame 600 includes a CMF 602 after the STA information list and may include padding 604 after the CMF. Alternatively, the CMF may be included in the padding of the secure NDP announcement frame 600. The MIC of the CMF may be calculated over the NDP announcement frame body, including the sounding dialog token, the STA information list fields, the security key ID field, and the PN field. UHR STAs that are associated with the AP may verify the secure NDP announcement frame 600. If those STAs are unable to verify the trigger frame because the computed MIC does not match the MIC in the trigger frame, then the STAs discard the NDP announcement frame. Other STAs that are not UHR STAs, such as HE or EHT STAs, may ignore the CMF 602 while processing the remainder of the NDP announcement frame 600. While the illustrated CMF 602 is similar to the CMF 300 shown in FIG. 3A, the present disclosure is not so limited, and a CMF in a secure NDP announcement frame may have other structures, such as the structure of the example CMF 350 illustrated in FIG. 3B.

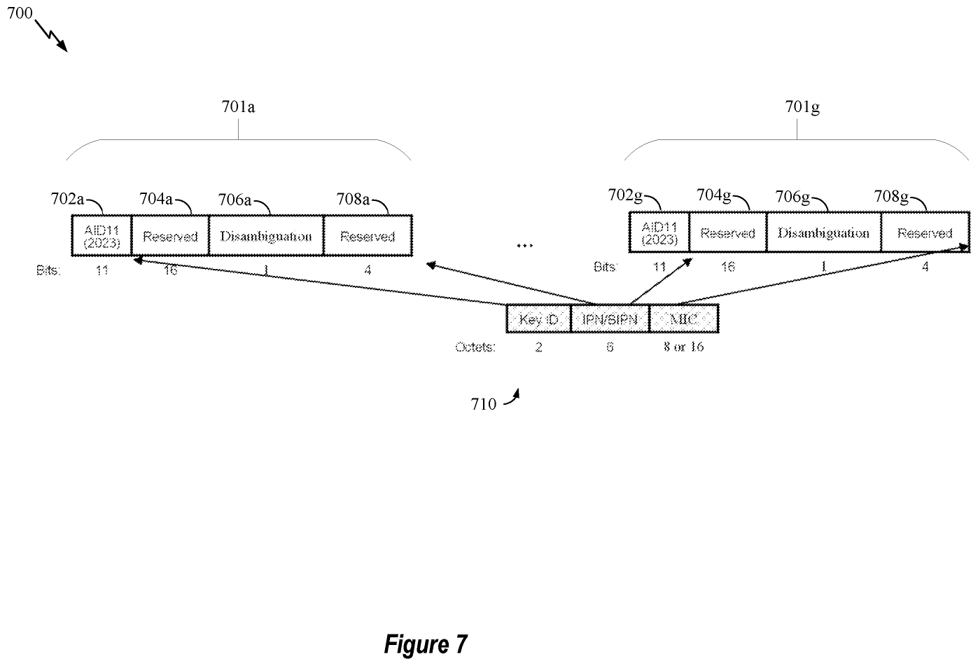

FIG. 7 illustrates an example 700 of incorporating a CMF 710 (which may be an example of CMFs 300 or 350, described above with reference to FIGS. 3A and 3B) into STA information list fields 701 of a NDP announcement frame, such as NDP announcement frame 600 (described above with reference to FIG. 6), in accordance with aspects of the present disclosure. Two STA information list fields 701a and 701g are illustrated, and each STA information list field includes four octets. The four octets of each of the STA information list fields include an association ID field 702 that includes eleven bits, a first field 704 that includes sixteen bits, a disambiguation field 706 that includes one bit, and a second field 708 that includes four bits. As illustrated, the bits of the CMF 710 may be included in the first fields 704a, 704b, 704c, etc. and second fields 708a, 708b, 708c, etc. of STA information list fields 701a, 701b, 701c, etc. that include an association ID field 702a, 702b, 702c, etc. that is set to a reserved value, such as 2023. When the MIC includes eight octets, then a CMF having the structure of CMF 300 may be included in seven STA information list fields of four octets each. When the MIC includes sixteen octets, then a CMF having the structure of CMF 300 may be included in ten STA information list fields of four octets each.

In aspects of the present disclosure, one or more reserved values of association IDs may indicate presence of a MIC in a field of a secure NDP announcement frame.

According to aspects of the present disclosure, a CMF may be included in a padding field of a secure NDP announcement frame, after a sequence of sixteen ones in the first two octets of the padding that is used to signal to receivers that padding has begun. The CMF may be included in the next eight or sixteen octets of the padding field, and additional bits after the CMF may be considered padding.

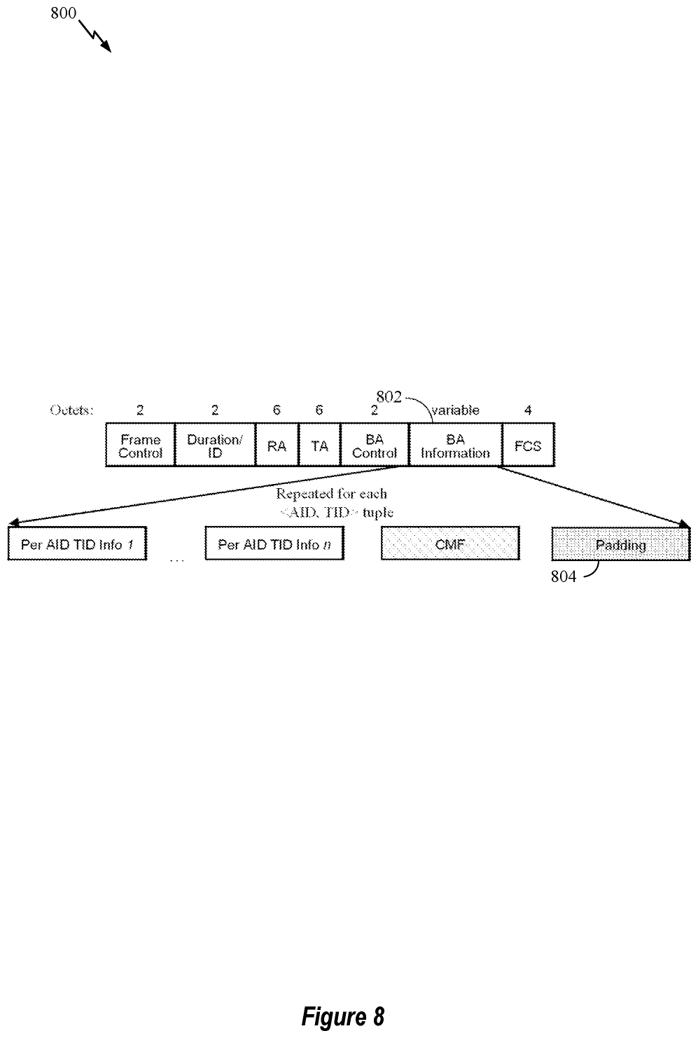

FIG. 8 illustrates an example secure M-BA frame 800, in accordance with aspects of the present disclosure. As illustrated, the secure M-BA frame 800 includes a CMF 802 in the block acknowledgment information list and may include padding 804 after the CMF 802. Alternatively, the CMF 802 may be included in the padding of the secure M-BA frame 800. The MIC of the CMF may be calculated over the M-BA frame body, including the BA control field and the preceding Per AID traffic identifier (TID) information fields. UHR STAs that are associated with the AP may verify the secure M-BA frame. If those STAs are unable to verify the secure M-BA frame because the computed MIC does not match the MIC in the trigger frame, then the STAs discard the secure M-BA frame and avoid losing packets that the invalid secure M-BA frame indicated were acknowledged. Other STAs that are not UHR STAs, such as HE or EHT STAs, may ignore the CMF 802 while processing the remainder of the secure M-BA frame 800. The structure of the illustrated CMF 802 may be similar to the structure of one of the CMFs 300 or 350 shown in FIGS. 3A and 3B, or another structure.

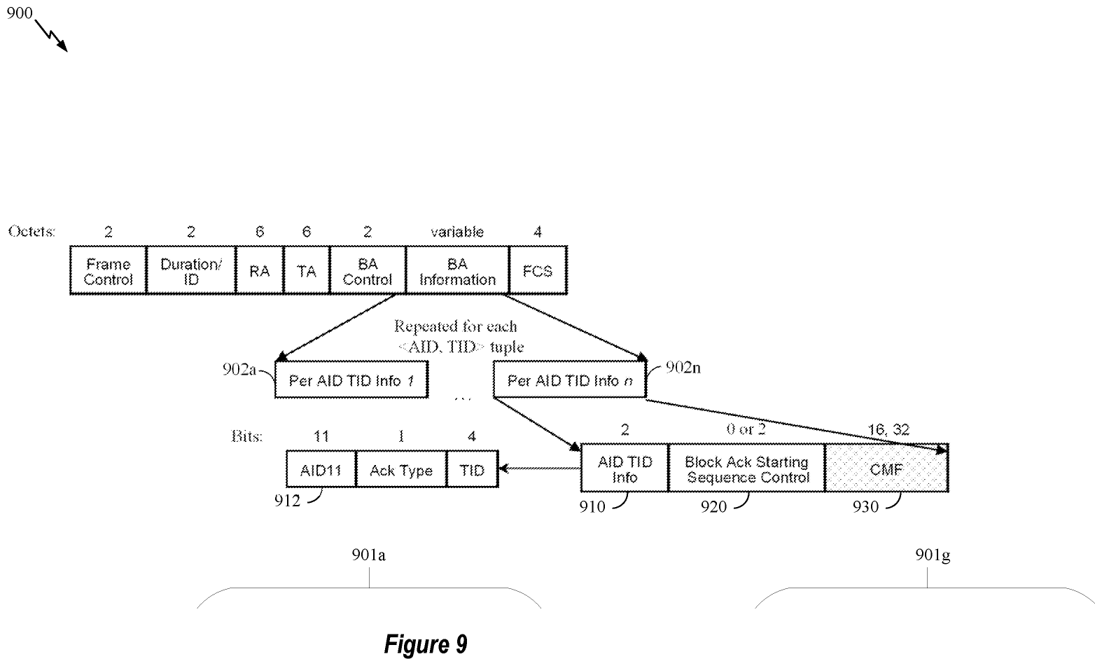

FIG. 9 illustrates an example 900 of incorporating a CMF 930 (which may be an example of CMFs 300 or 350, described above with reference to FIGS. 3A and 3B) into a Per AID TID information field 902 of a secure M-BA frame, such as secure M-BA frame 800 (described above with reference to FIG. 8), in accordance with aspects of the present disclosure. Two Per AID TID information fields 902a and 902n are illustrated, and the Per AID TID information field 902n, which is configured to convey a CMF 930, may include 18 to 36 octets, including an AID TID information field 910 that includes two octets, a block ACK starting sequence control field 920 that includes zero or two octets, and a CMF 930 that includes sixteen or thirty-two octets. As illustrated, the AID TID information field 910 may include an AID field 912 that includes eleven bits and may be set to a reserved value, such as 2023, to indicate the presence of the CMF in the Per AID TID information field 902n. The CMF 930 having the structure of CMF 300 may include sixteen octets when the MIC includes eight octets, and the CMF 930 having the structure of CMF 300 may include 32 octets when the MIC includes sixteen octets. An FN subfield of the block ACK starting sequence control field 920 may indicate the CMF field length.

In aspects of the present disclosure, one or more reserved values of association IDs may indicate presence of a CMF in a Per AID TID information field of a secure M-BA frame.

According to aspects of the present disclosure, a CMF may be included in a secure compressed block acknowledgment (C-BA) frame in a manner similar to that described for a secure M-BA frame.

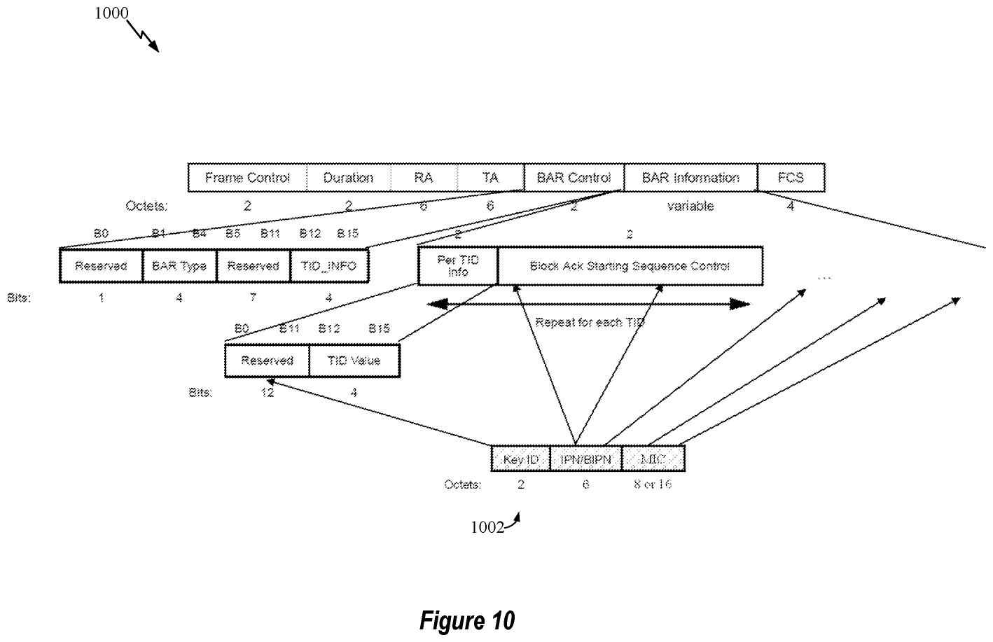

FIG. 10 illustrates an example secure multiple traffic identifier (multi-TID) block acknowledgment request (BAR) frame 1000, in accordance with aspects of the present disclosure. As illustrated, the secure multi-TID BAR frame 1000 includes a CMF 1002 after the last useful BAR information list and may include padding after the CMF 1002. Alternatively, the CMF may be included in the padding of the secure multi-TID BAR frame 1000. The MIC of the CMF may be calculated over the secure multi-TID BAR frame body, including the BAR control field, the BAR information fields, the security key ID field, and the PN field. UHR STAs that are associated with the AP may verify the secure multi-TID BAR frame. If those STAs are unable to verify the secure multi-TID BAR frame because the computed MIC does not match the MIC in the secure multi-TID BAR frame, then the STAs discard the secure multi-TID BAR frame. Other STAs that are not UHR STAs, such as HE or EHT STAs, may ignore the CMF 1002 while processing the remainder of the secure multi-TID BAR frame 1000. As illustrated, the CMF 1002 may be included in a BAR information field that has a first bit (which is in a set of twelve bits that are typically considered as reserved) of a Per TID information field set to indicate the presence of the CMF. The bits of the CMF 1002 may be included in the block ACK starting sequence control and other fields of the BAR information field. A sequence of ones can be used to indicate padding after the CMF. While the illustrated CMF 1002 is similar to the CMF 300 shown in FIG. 3A, the present disclosure is not so limited, and a CMF in a secure multi-TID BAR frame may have other structures, such as the structure of the example CMF 350 illustrated in FIG. 3B.

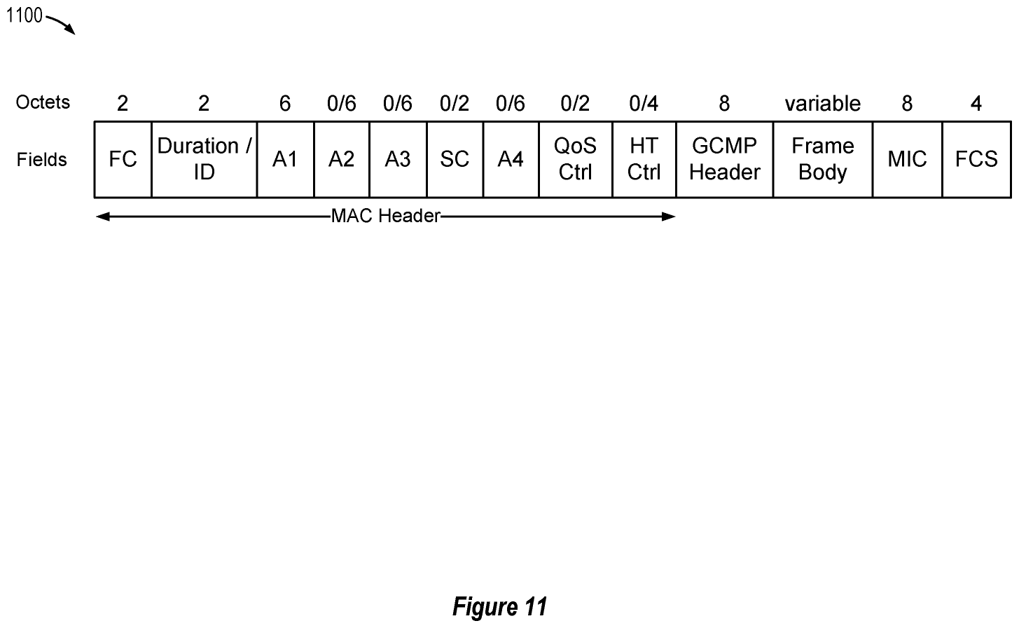

FIG. 11 illustrates an example MPDU 1100, in accordance with certain aspects of the present disclosure. An additional control field (e.g., a high efficiency (HE) Control field) may be added to the MAC header of the MPDU 1100 in order to provide certain control information.

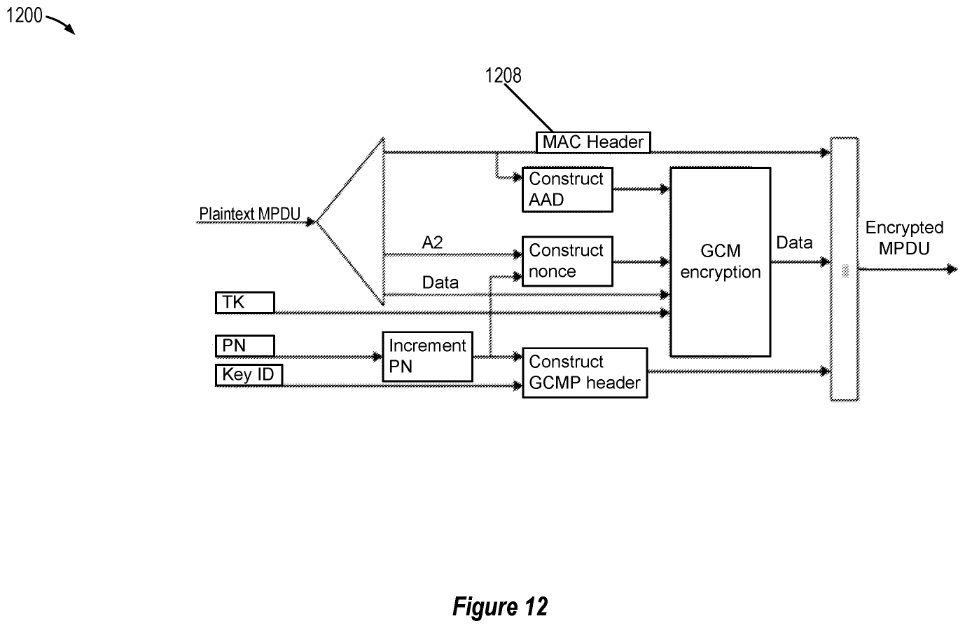

FIG. 12 illustrates an example algorithm 1200 for encrypting data of an MPDU. As shown in the example algorithm 1200, the MAC header 1208 is not encrypted in the Galois/counter mode (GCM) encryption block, and so the unencrypted MAC header is transmitted with the encrypted data. In the example algorithm 1200, some portions of some fields of the MAC header of the MPDU 1100 are protected from alteration by being included in additional authenticated data (AAD) of the MPDU. If an attacker attempts to alter the portions of the fields included in the AAD of a transmitted MPDU or while transmitting a repetition of an MPDU (e.g., an attacking frame), a recipient may detect the changes and reject (e.g., discard) the attacking frame. Some bits of the frame control (FC) field of the example MPDU 1100 are not protected by the AAD. The AAD does not protect the three least significant bits of the Subtype subfield of the FC field (i.e., bits 4, 5, and 6 of the FC field), the retry subfield (i.e., bit 11 of the FC field), the power management subfield (i.e., bit 12 of the FC field), and the more data subfield (i.e., bit 13 of the FC field). In addition, the AAD does not protect the +HTC subfield (i.e., bit 15 of the FC field) in data frames containing a QoS Control field. The AAD also does not protect the sequence number subfield (i.e., bits 4 through 15) of the Sequence Control (SC) field. The AAD also does not protect the QoS Control field, except for the TID subfield within the QoS Control field. In addition, the AAD does not protect the Duration/ID and HT Control fields.

Because certain algorithms do not encrypt some header fields of an MPDU, those header fields may be used to track a node's (e.g., a STA's or AP's) activity. For example, a STA's participation in a video call via a Wi-Fi network may be trackable, and other activities by the same STA may also be linked to the STA. Accordingly, it is desirable to development methods and apparatus for encrypting one or more subfields and fields of a MAC header of an MPDU. Such encryption may improve user privacy for a user of a node.

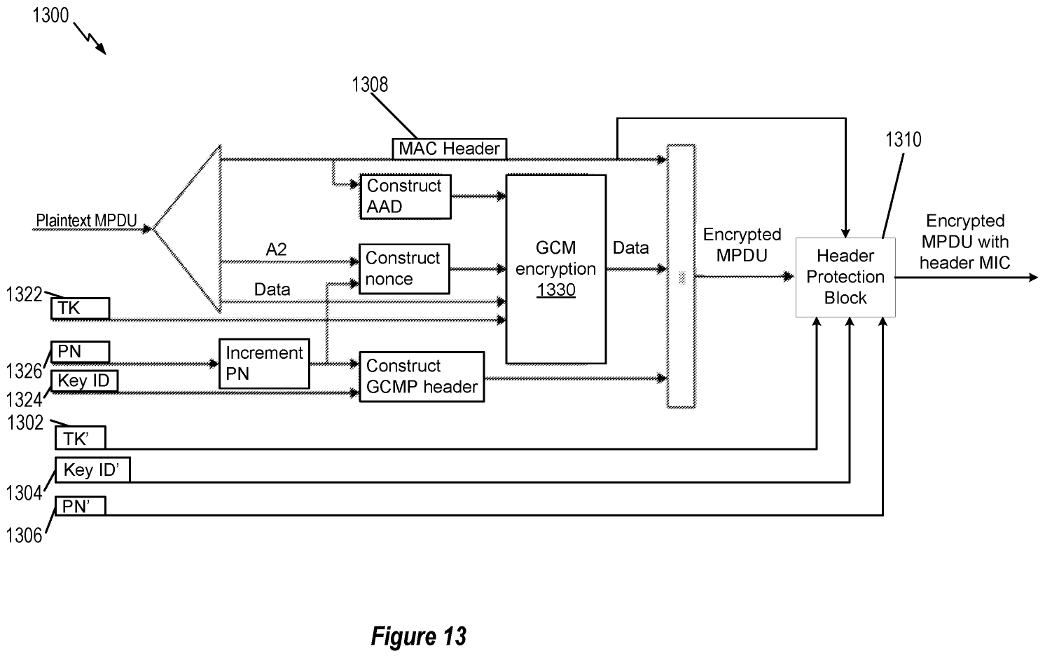

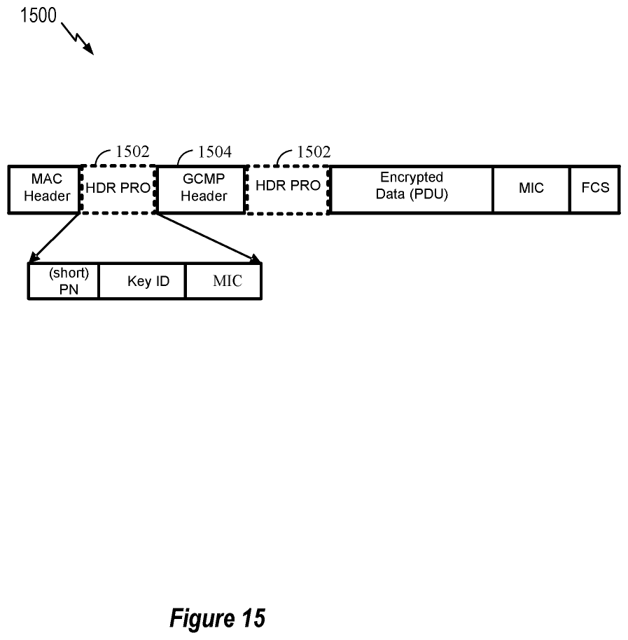

FIG. 13 illustrates an example algorithm 1300 for encrypting MAC header fields and protecting those fields for an individually addressed QoS data frame or management frame ((M)MPDU). As shown in the example algorithm 1300, an encryption key (TK′) 1302, a key ID 1304 of the encryption key (Key ID′), and a packet number (PN′) 1306 for the MAC header 1308 are provided to a header protection block 1310. The encryption key (TK′) 1302, PN′ 1306, and key ID′ 1304 provided to the header protection block 1310 may not be the same as the encryption key (TK) 1322, PN 1326, and key ID 1324 used by the GCM encryption block 1330 for encrypting the data of the MPDU and determining the MIC used to protect that data. The encryption key 1302 is used to encrypt one or more portions of the MAC header, a MIC for the MAC header is calculated, and an indication of the PN′ 1306, an indication of the key ID′ 1304, and an indication of the HDR MIC are placed, by the header protection block 1310, in a header protection field (see FIG. 15) of the individually addressed QoS data frame or the management frame ((M)MPDU).

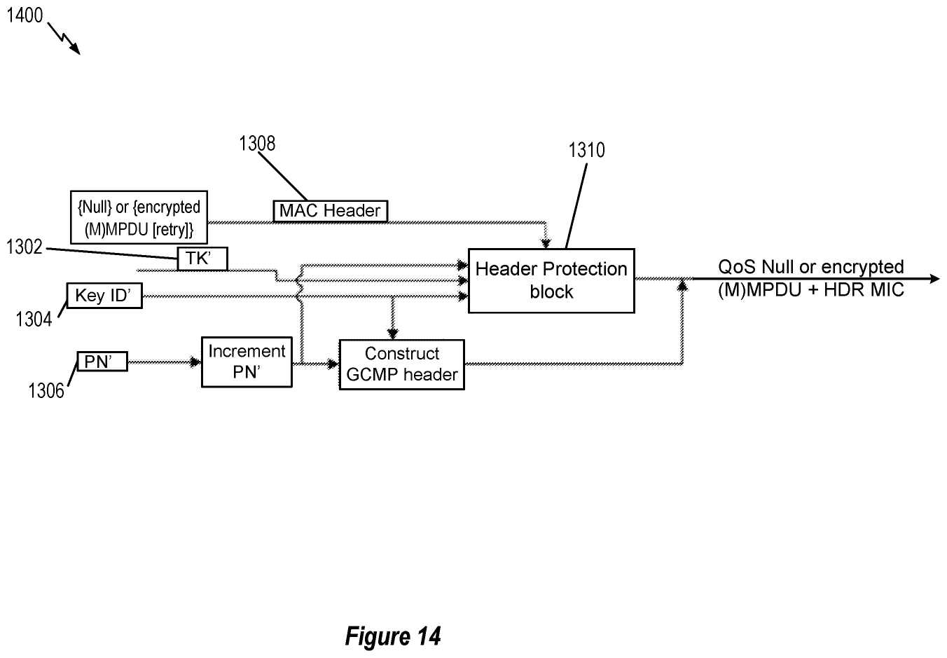

FIG. 14 illustrates an example algorithm 1400 for encrypting MAC header fields and protecting those fields for a QoS Null frame, a retried QoS data frame, or a retried management frame ((M)MPDU). Items in example algorithm 1400 that were previously described with reference to FIG. 13 are not further described. Because the QoS Null frame does not include data, the GCM encryption block 1330 (shown in FIG. 13) for that type of frame is absent in example algorithm 1400. Because the retried QoS data frame or the retried (M)MPDU are each transporting the same encrypted data as the original QoS data frame or the original (M)MPDU (i.e., the original QoS data frame or the original (M)MPDU that is being retried/retransmitted, and note that the retry subfield of the FC field is not protected by the AAD, as described above), the GCM encryption block is also absent for those types of frames in example algorithm 1400. As described above with reference to FIG. 13, an indication of the PN′ 1306, an indication of the key ID′ 1304, and an indication of the HDR MIC are placed, by the header protection block 1310, in a header protection field (see FIG. 15) of the QoS Null frame, the retried QoS data frame, or the retried (M)MPDU.

FIG. 15 illustrates an example of incorporating a header protection (HDR PRO) field 1502 into an MPDU 1500. As illustrated, a HDR PRO field 1502 may be included before or after a Galois/counter mode protocol (GCMP) header 1504 of the MPDU. The HDR PRO field may include an indication of the packet number (PN) associated with the MAC header. The indication may be a shortened version of the PN associated with the MAC header. The HDR PRO may also include an indication of the key ID of the key used for encrypting the encrypted portions of the MAC header. The HDR PRO may also include an indication of a MIC for the MAC header. The indication of the MIC may be a shortened version of the MIC calculated for the MAC header.

Because group address frames may be received by legacy STAs that are not capable of decrypting an encrypted MAC header, it is desirable to protect MAC headers of group address frames without encrypting the MAC headers of the group address frames.

In aspects of the present disclosure, a MAC header of a group address frame may be protected by a follow-up frame without the MAC header of the group address frame being encrypted. A transmitter (e.g., a STA or an AP) transmitting a group address frame may transmit the group address frame according to previously known techniques and then transmit a follow-up frame one SIFS later than the group address frame. The transmitter may include indications of a PN, key ID, and MIC for the header of the group address frame in the follow-up frame. Legacy STAs that are not capable of decrypting the follow-up frame ignore the follow-up frame. STAs that are embodiments of the present disclosure can receive the follow-up frame and validate the preceding group address frame with the PN, key ID, and MIC indicated in the follow-up frame.

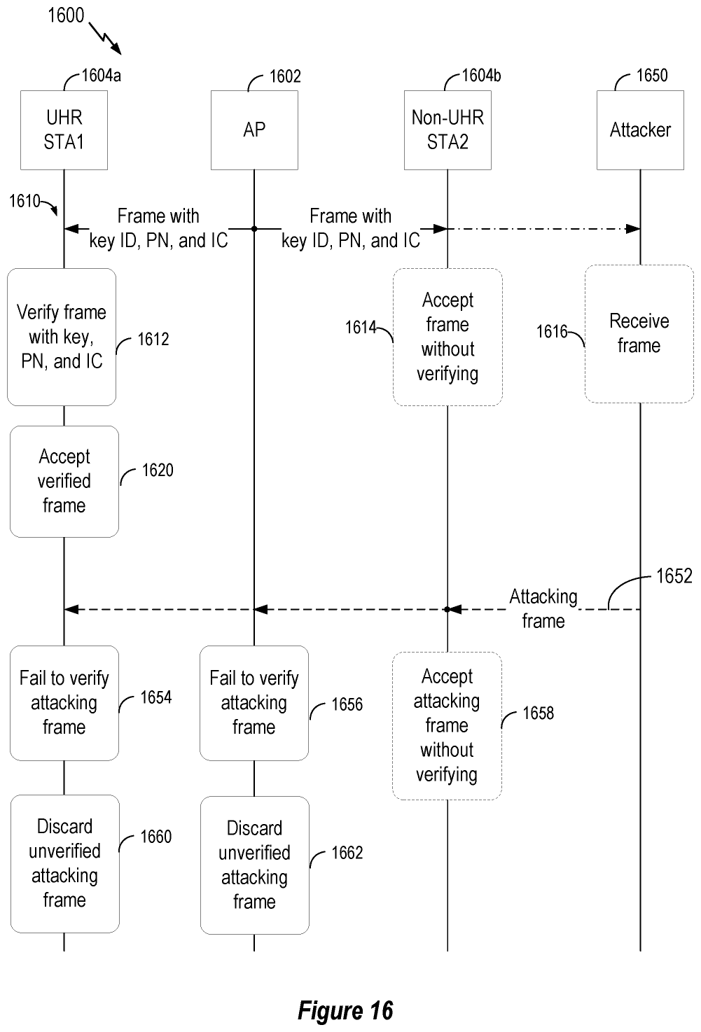

FIG. 16 is an example call flow 1600 illustrating communications among an AP 1602, a UHR STA 1604a, a non-UHR STA 1604b, and an attacker device 1650. At 1610, the AP 1602 transmits a frame including a security key ID, a PN, and an IC. At 1612, the UHR STA 1604a verifies the frame by comparing the PN with an expected PN for the frame and by comparing the IC received with the frame with another IC calculated for the frame based at least on the security key indicated by the ID. At 1620, the UHR STA 1604a accepts the verified frame and acts in accordance with the verified frame. At 1614, the non-UHR STA 1604b accepts the frame without verifying the frame and acts in accordance with the frame. At 1616, the attacker device 1650 receives the frame, possibly recording or analyzing the frame. At 1652, the attacker device 1650 sends an attacking frame (such as a replay of the frame 1610, or a defective block acknowledgment frame). At 1654, the UHR STA 1604a fails to verify the attacking frame, and at 1660, the UHR STA 1604a discards the unverified attacking frame. Similarly, at 1656, the AP 1602 fails to verify the attacking frame, and at 1662, the AP 1602 discards the unverified attacking frame. At 1658, the non-UHR STA 1604b accepts the attacking frame (without verifying the attacking frame) and acts in accordance with the attacking frame.

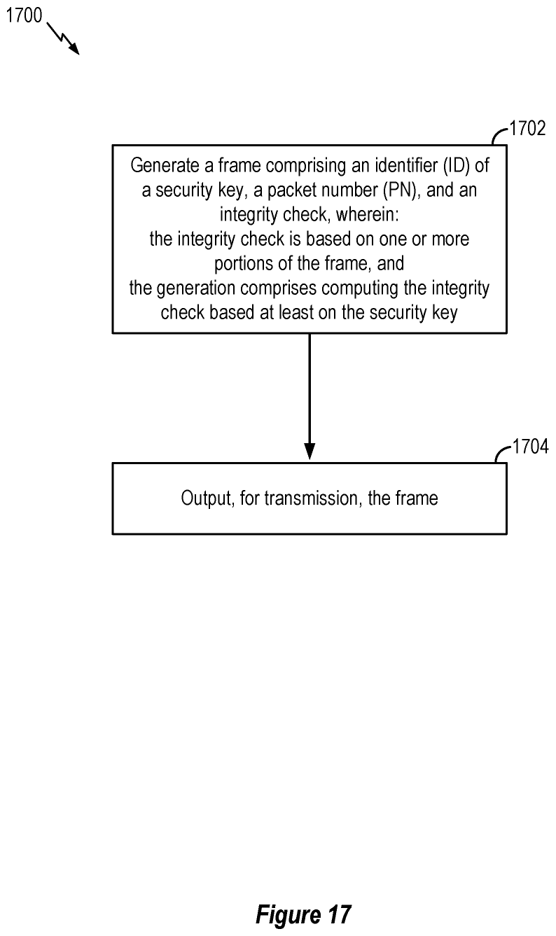

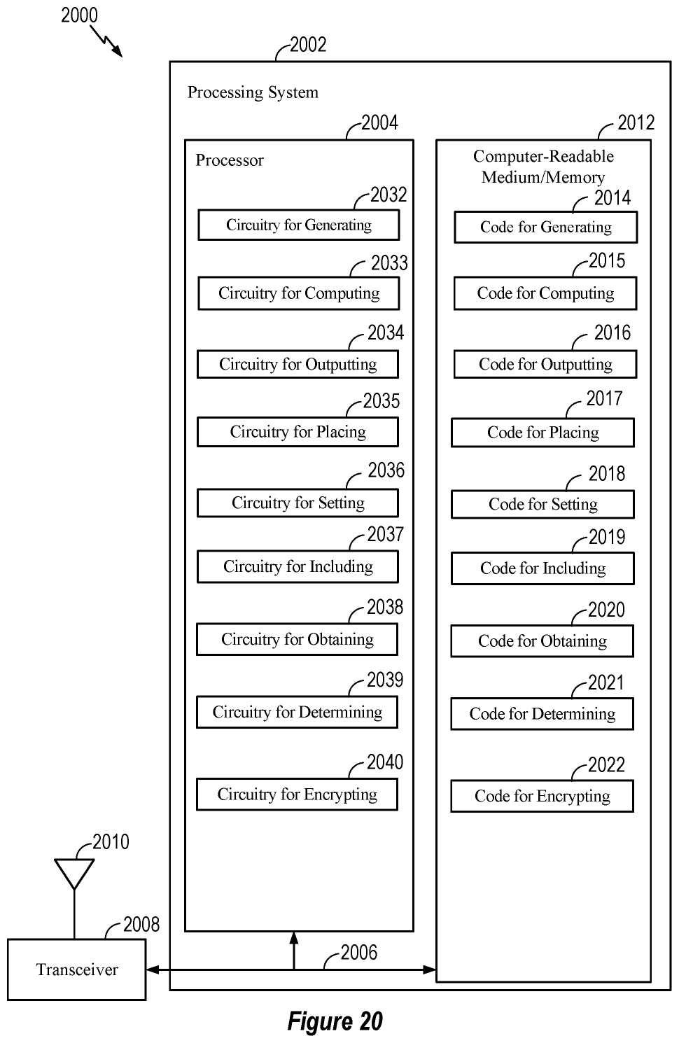

FIG. 17 shows a flowchart illustrating an example process 1700 performable at a wireless transmitter that supports securing frames according to some aspects of the present disclosure. The operations of the process 1700 may be implemented by a wireless AP or UE or components of a wireless AP or UE as described herein. For example, the process 1700 may be performed by a wireless communication device, such as the wireless communication device 2000 described with reference to FIG. 20, operating as or within a wireless AP or UE. In some examples, the process 1700 may be performed by a wireless AP such as one of the APs 102 described with reference to FIG. 1. In some examples, the process 1700 may be performed by a wireless STA such as one of the STAs 104 described with reference to FIG. 1.

In some examples, in block 1702, the wireless transmitter generates a frame comprising an identifier (ID) of a security key, a packet number (PN), and an integrity check, wherein: the integrity check is based on one or more portions of the frame, and the generation comprises computing the integrity check based at least on the security key.

In block 1704, the wireless transmitter outputs, for transmission, the frame.

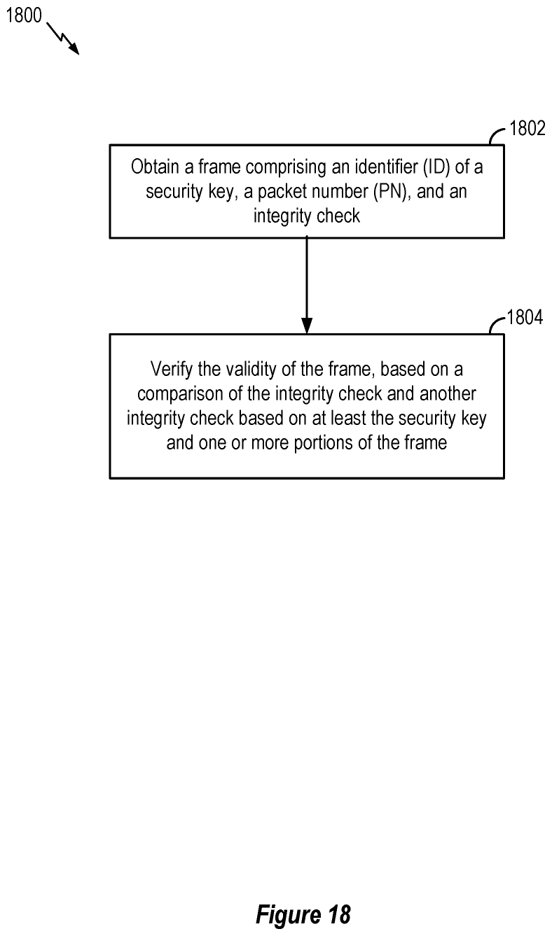

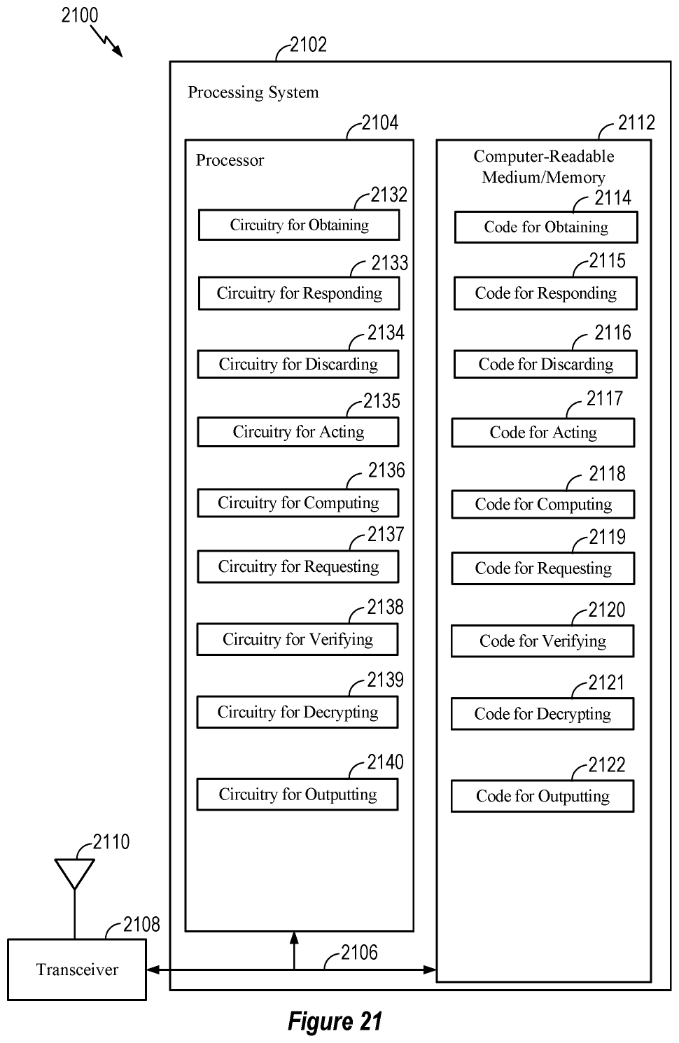

FIG. 18 shows a flowchart illustrating an example process 1800 performable at a wireless receiver that supports securing frames according to some aspects of the present disclosure. The operations of the process 1800 may be implemented by a wireless STA or AP or components of a wireless STA or AP as described herein. For example, the process 1800 may be performed by a wireless communication device, such as the wireless communication device 2100 described with reference to FIG. 21, operating as or within a wireless STA or AP. In some examples, the process 1800 may be performed by a wireless STA such as one of the STAs 104 described with reference to FIG. 1. In some examples, the process 1800 may be performed by a wireless AP such as one of the APs 102 described with reference to FIG. 1.

In some examples, in block 1802, the wireless receiver obtains a frame comprising an identifier (ID) of a security key, a packet number (PN), and an integrity check.

In block 1804, the wireless receiver verifies the validity of the frame, based on a comparison of the integrity check and another integrity check based on at least the security key and one or more portions of the frame.

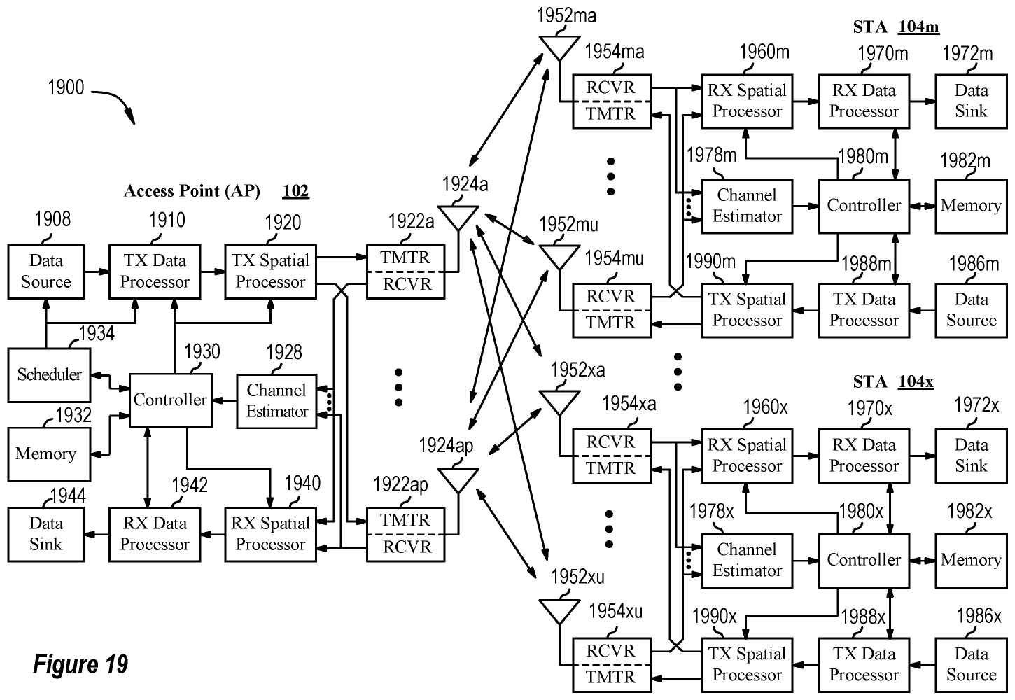

FIG. 19 illustrates a block diagram of AP 102 and two wireless STAs 104m and 104x in a MIMO/MLO system, such as wireless communication network 100, in accordance with certain aspects of the present disclosure. In certain aspects, AP 102 and/or wireless STAs 104m and 104x may perform various techniques to secure frames, especially frames including control information.

AP 102 is equipped with Nₐₚ antennas 1924a through 1924ap. Wireless STA 104m is equipped with N_{sta,m} antennas 1952ma through 1952mu, and wireless STA 104x is equipped with N_{sta,x} antennas 1952xa through 1952xu. AP 102 is a transmitting entity for the DL and a receiving entity for the UL. Each wireless STA 104 is a transmitting entity for the UL and a receiving entity for the DL. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “DL” denotes the downlink, the subscript “UL” denotes the uplink, N_{UL} wireless STAs are selected for simultaneous transmission on the uplink, N_{DL} wireless STAs are selected for simultaneous transmission on the downlink, N_{UL} may or may not be equal to N_{DL}, and N_{UL} and N_{DL} may be static values or can change for each scheduling interval. Beam-steering, beamforming, or some other spatial processing technique may be used at the access point and wireless station.

On the UL, at each wireless STA 104 selected for UL transmission, a transmit (TX) data processor 1988 receives traffic data from a data source 1986 and control data from a controller 1980. TX data processor 1988 processes (e.g., encodes, interleaves, and modulates) the traffic data for the wireless station based on the coding and modulation schemes associated with the rate selected for the wireless STA and provides a data symbol stream. A TX spatial processor 1990 performs spatial processing on the data symbol stream and provides N_{sta,m} transmit symbol streams for the N_{sta,m} antennas. Each transceiver (TMTR) 1954 receives and processes (e.g., converts to analog, amplifies, filters, and frequency upconverts) a respective transmit symbol stream to generate an uplink signal. N_{sta,m} transceivers 1954 provide N_{sta,m} UL signals for transmission from N_{sta,m} antennas 1952 to AP 102. Memory 1982 may store data and program codes for the user terminal 104 and may interface with the controller 1980.

N_{UL} wireless STAs may be scheduled for simultaneous transmission on the uplink. Each of these wireless STAs performs spatial processing on its data symbol stream and transmits its set of transmit symbol streams on the UL to the AP 102.

At AP 102, Nₐₚ antennas 1924a through 1924ap receive the UL signals from all N_{UL} wireless STAs transmitting on the UL. Each antenna 1924 provides a received signal to a respective transceiver (RCVR) 1922. Each transceiver 1922 performs processing complementary to that performed by transceiver 1954 and provides a received symbol stream. A receive (RX) spatial processor 1940 performs receiver spatial processing on the Nₐₚ received symbol streams from Nₐₚ transceivers 1922 and provides N_{UL} recovered UL data symbol streams. The receiver spatial processing is performed in accordance with channel correlation matrix inversion (CCMI), minimum mean square error (MMSE), soft interference cancellation (SIC), or some other technique. Each recovered UL data symbol stream is an estimate of a data symbol stream transmitted by a respective wireless station. An RX data processor 1942 processes (e.g., demodulates, deinterleaves, and decodes) each recovered uplink data symbol stream in accordance with the rate used for that stream to obtain decoded data. The decoded data for each wireless STA may be provided to a data sink 1944 (e.g., corresponding to data sinks 1972 of UTs 104) for storage and/or a controller 1930 for further processing.

On the DL, at AP 102, a TX data processor 1910 receives traffic data from a data source 1908 for N_{DL} wireless stations scheduled for downlink transmission, control data from a controller 1930, and possibly other data from a scheduler 1934. The various types of data may be sent on different transport channels. TX data processor 1910 processes (e.g., encodes, interleaves, and modulates) the traffic data for each wireless station based on the rate selected for that wireless station. TX data processor 1910 provides N_{DL} DL data symbol streams for the N_{DL} wireless stations. A TX spatial processor 1920 performs spatial processing (such as a precoding or beamforming, as described in the present disclosure) on the N_{DL} DL data symbol streams, and provides Nₐₚ transmit symbol streams for the Nₐₚ antennas. Each transceiver 1922 receives and processes a respective transmit symbol stream to generate a DL signal. Nₐₚ transceivers 1922 provide Nₐₚ DL signals for transmission from Nₐₚ antennas 1924 to the wireless STAs. Memory 1932 may store data and program codes for the access point 102 and may interface with the controller 1930.

At each wireless STA 104, N_{sta,m} antennas 1952 receive the Nₐₚ DL signals from access point 102. Each transceiver 1954 processes a received signal from an associated antenna 1952 and provides a received symbol stream. An RX spatial processor 1960 performs receiver spatial processing on N_{sta,m} received symbol streams from N_{sta,m} transceivers 1954 and provides a recovered DL data symbol stream for the wireless station. The receiver spatial processing is performed in accordance with the CCMI, MMSE or some other technique. An RX data processor 1970 processes (e.g., demodulates, deinterleaves and decodes) the recovered DL data symbol stream to obtain decoded data for the wireless station.

At each wireless STA 104, a channel estimator 1978 estimates the DL channel response and provides DL channel estimates, which may include channel gain estimates, SNR estimates, noise variance and so on. Similarly, a channel estimator 1928 estimates the UL channel response and provides UL channel estimates. Controller 1980 for each wireless STA typically derives the spatial filter matrix for the wireless station based on the downlink channel response matrix H_{dn,m} for that wireless station. Controller 1930 derives the spatial filter matrix for the AP based on the effective UL channel response matrix H_{up,eff}. Controller 1980 for each wireless STA may send feedback information (e.g., the downlink and/or uplink eigenvectors, eigenvalues, SNR estimates, and so on) to the AP. Controllers 1930 and 1980 also control the operation of various processing units at AP 102 and wireless STA 104, respectively.

### Example Devices

FIG. 20 illustrates a communications device 2000 that may include various components (such as corresponding to means-plus-function components) operable, configured, or adapted to perform operations for the techniques disclosed herein, such as the operations illustrated in FIG. 17.

Communications device 2000 includes a processing system 2002 coupled to a transceiver 2008 (such as a transmitter or a receiver). Transceiver 2008 is configured to transmit and receive signals for the communications device 2000 via an antenna 2010, such as the various signals as described herein. Processing system 2002 may be configured to perform processing functions for the communications device 2000, including processing signals received or to be transmitted by the communications device 2000.

Processing system 2002 includes a processor 2004 coupled to a computer-readable medium/memory 2012 via a bus 2006. In certain aspects, computer-readable medium/memory 2012 is configured to store instructions (such as computer-executable code) that when executed by processor 2004, cause processor 2004 to perform the operations illustrated in FIG. 17 or other operations for performing the various techniques discussed herein.

In certain aspects, computer-readable medium/memory 2012 stores code 2014 (such as an example of means for) for generating, code 2015 (such as an example of means for) for computing, code 2016 (such as an example of means for) for outputting, code 2017 (such as an example of means for) for placing, code 2018 (such as an example of means for) for setting, code 2019 (such as an example of means for) for including, code for obtaining 2020, code for determining 2021, and code for encrypting 2022.

In certain aspects, processor 2004 has circuitry configured to implement the code stored in the computer-readable medium/memory 2012. Processor 2004 includes circuitry 2032 (such as an example of means for) for generating, circuitry 2033 (such as an example of means for) for computing, circuitry 2034 (such as an example of means for) for outputting, circuitry 2035 (such as an example of means for) for placing, circuitry 2036 (such as an example of means for) for setting, circuitry 2037 (such as an example of means for) for including, circuitry 2038 (such as an example of means for) for obtaining, circuitry 2039 (such as an example of means for) for determining, and circuitry 2040 (such as an example of means for) for encrypting.

Transceiver 2008 may provide a means for receiving information such as packets, user data, or control information associated with various information channels (such as control channels, data channels, etc.). Information may be passed on to other components of the device 2000. Transceiver 2008 may be an example of aspects of the transceiver 1954 described with reference to FIG. 19. Antenna 2010 may correspond to a single antenna or a set of antennas. Transceiver 2008 may provide means for transmitting signals generated by other components of the device 2000.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

Means for generating, means for computing, means for placing, means for setting, means for including, means for determining, and/or means for encrypting may include any of the various processors and/or memories shown in FIG. 19 or 20. Means for obtaining and/or means for outputting may include any of the various processors, memories, and/or transceivers shown in FIG. 19 or 20.

FIG. 21 illustrates a communications device 2100 that may include various components (such as corresponding to means-plus-function components) operable, configured, or adapted to perform operations for the techniques disclosed herein, such as the operations illustrated in FIG. 18.

Communications device 2100 includes a processing system 2102 coupled to a transceiver 2108 (such as a transmitter or a receiver). Transceiver 2108 is configured to transmit and receive signals for the communications device 2100 via an antenna 2110, such as the various signals as described herein. Processing system 2102 may be configured to perform processing functions for the communications device 2100, including processing signals received or to be transmitted by the communications device 2100.

Processing system 2102 includes a processor 2104 coupled to a computer-readable medium/memory 2112 via a bus 2106. In certain aspects, computer-readable medium/memory 2112 is configured to store instructions (such as computer-executable code) that when executed by processor 2104, cause processor 2104 to perform the operations illustrated in FIG. 18 or other operations for performing the various techniques discussed herein.

In certain aspects, computer-readable medium/memory 2112 stores code 2114 (such as an example of means for) for obtaining, code 2115 (such as an example of means for) for responding, code 2116 (such as an example of means for) for discarding, code 2117 (such as an example of means for) for acting, code 2118 (such as an example of means for) for computing, code 2119 (such as an example of means for) for requesting, code for verifying 2120, code for decrypting 2121, and code for outputting 2122.

In certain aspects, processor 2104 has circuitry configured to implement the code stored in the computer-readable medium/memory 2112. Processor 2104 includes circuitry 2132 (such as an example of means for) for obtaining, circuitry 2133 (such as an example of means for) for responding, circuitry 2134 (such as an example of means for) for discarding, circuitry 2135 (such as an example of means for) for acting, circuitry 2136 (such as an example of means for) for computing, circuitry 2137 (such as an example of means for) for requesting, circuitry 2138 (such as an example of means for) for verifying, circuitry 2139 (such as an example of means for) for decrypting, and circuitry 2140 (such as an example of means for) for outputting.

Transceiver 2108 may provide a means for receiving information such as packets, user data, or control information associated with various information channels (such as control channels, data channels, etc.). Information may be passed on to other components of the device 2100. Transceiver 2108 may be an example of aspects of the transceiver 1954 described with reference to FIG. 19. Antenna 2110 may correspond to a single antenna or a set of antennas. Transceiver 2108 may provide means for transmitting signals generated by other components of the device 2100.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. A device obtaining a frame may obtain values of various fields of the frame as part of the obtaining, or additionally or alternatively, the device may obtain the frame and obtain values of various fields of the frame in a later step, such as a decrypting step. In some cases, the interface to output a frame for transmission and the interface to obtain a frame (which may be referred to as first and second interfaces herein) may be the same interface.

Means for responding, means for discarding, means for acting, means for computing, means for requesting, means for verifying, and/or means for decrypting may include any of the various processors and/or memories shown in FIG. 19 or 21. Means for obtaining and/or means for outputting may include any of the various processors, memories, and/or transceivers shown in FIG. 19 or 21.

### EXAMPLE CLAUSES

Implementation examples are described in the following numbered clauses:

Clause 1: A method for wireless communications at a wireless node, including: generating a frame including an identifier (ID) of a security key, a packet number (PN), and an integrity check, where: the integrity check is based on one or more portions of the frame, and the generation includes computing the integrity check based at least on the security key; and outputting, for transmission, the frame.

Clause 2: The method of Clause 1, where the PN includes at least one of an integrity group temporal key (IGTK) packet number or an integrity pairwise temporal key (IPTK) packet number.

Clause 3: The method of Clause 1, where: the PN includes only a portion of a complete packet number for the frame; another portion of the complete packet number is stored locally; and the method further includes updating the stored portion of the complete packet number based on an exchange of secure management frames.

Clause 4: The method of Clause 3, where: the complete packet number includes a global timestamp that is maintained by the wireless node or an access point (AP) that is an intended recipient of the frame; when the global timestamp is maintained by the AP, the method further includes: obtaining one or more protected Beacon frames in which the global timestamp is indicated; and when the global timestamp is maintained by the wireless node, the method further includes: outputting, for transmission, one or more protected Beacon frames indicating the global timestamp.

Clause 5: The method of any of clauses 1-4, where the security key includes at least one of: an integrity group temporal key (IGTK), a pairwise temporal key (PTK), or a control integrity temporal key (CIGTK).

Clause 6: The method of any of Clauses 1-5, where: the frame includes a trigger frame including a user information list; and the method further includes: placing the ID, the PN, and the integrity check after the user information list in the trigger frame.

Clause 7: The method of any of Clauses 1-5, where: the frame includes a trigger frame including a user information list including user information fields; and the method further includes: placing the ID, the PN, and the integrity check in a subset of the user information fields.

Clause 8: The method of Clause 7, where: each of the user information fields of the subset includes an association identifier (AID) field; and the method further includes: setting the AID field, of each user information field in the subset, to a reserved value that indicates a presence of the integrity check.

Clause 9: The method of Clause 7, where: the integrity check is conveyed via eight octets or sixteen octets; when the integrity check is conveyed via eight octets, the subset consists of five user information fields; and when the integrity check is conveyed via sixteen octets, the subset consists of seven user information fields.

Clause 10: The method of any of Clauses 1-9, where at least one of: the integrity check is a portion of a complete integrity check for the frame; or a complete integrity check includes the integrity check and a portion of the complete integrity check known by another wireless node that is an intended recipient of the frame.

Clause 11: The method of any of Clauses 1-10, where: the frame includes a null data packet (NDP) announcement frame including station (STA) information fields; and the method further includes: placing the ID, the PN, and the integrity check after the STA information fields in the NDP announcement frame.

Clause 12: The method of any of Clauses 1-11, where: the frame includes a null data packet (NDP) announcement frame including station (STA) information fields; and the method further includes: placing the ID, the PN, and the integrity check in a subset of the STA information fields.

Clause 13: The method of Clause 12, where: each STA information field includes an association identifier (AID) field; and the method further includes: setting the AID field, of each STA information field in the subset, to a reserved value that indicates a presence of the integrity check.

Clause 14: The method of Clause 12, where: the integrity check is conveyed via eight octets or sixteen octets; when the integrity check is conveyed via eight octets, the subset consists of seven STA information fields; and when the integrity check is conveyed via sixteen octets, the subset consists of ten STA information fields.

Clause 15: The method of any of Clauses 1-14, where: the frame includes a multi-station block acknowledgment (M-BA) frame including association identifier (AID) traffic identifier (TID) information fields; and the method further includes: placing the ID, the PN, and the integrity check in a subset of the AID TID information fields.

Clause 16: The method of Clause 15, where: each of the AID TID information fields of the subset includes an AID field; and the method further includes: setting the AID field, of each AID TID information field of the subset, to a reserved value that indicates a presence of the integrity check.

Clause 17: The method of Clause 15, further including: including padding in the frame after the subset, where a quantity of the padding is based on a number of symbols between the subset and an end of the frame.

Clause 18: The method of Clause 17, further including: obtaining an indication of a requested period between the subset and the end of the frame; and determining the number of symbols based on the requested period.

Clause 19: The method of any of Clauses 1-18, where: the frame includes a block acknowledgment request (BAR) frame including BAR information fields; and the method further includes: placing the ID, the PN, and the integrity check in a subset of the BAR information fields.

Clause 20: The method of Clause 19, where the BAR frame includes a multiple traffic identifier (multi-TID) BAR frame or a compressed BAR frame.

Clause 21: The method of Clause 19, where: each of the BAR information fields of the subset includes a Per traffic identifier (TID) info field; and the method further includes: setting a first bit of each Per TID info field.

Clause 22: The method of any of Clauses 1-21, where the integrity check includes a message integrity code (MIC).

Clause 23: The method of any of Clauses 1-22, wherein generating the frame includes: encrypting one or more bits included in a medium access control (MAC) header of the frame, wherein outputting the frame comprises outputting the MAC header including the encrypted one or more bits.

Clause 24: The method of Clause 23, wherein at least one of: the PN is a first PN associated with a MAC protocol data unit (MPDU) of the frame; or encrypting the one or more bits is based on a second PN associated with the MAC header and a second security key.

Clause 25: The method of Clause 24, wherein the frame further includes a header protection field comprising: an indication of the second PN; an ID of the second security key; and another integrity check based on the MAC header.

Clause 26: The method of any of Clauses 23-25, further including: obtaining an indication that another wireless node supports MAC header encryption, wherein the MAC header indicates a receiver address (RA) of the other wireless node.

Clause 27: The method of any of Clauses 23-26, further including: outputting, for transmission, an indication that the wireless node supports MAC header encryption.

Clause 28: A method for wireless communications at a wireless node, including: obtaining a frame including an identifier (ID) of a security key, a packet number (PN), and an integrity check; and verifying the validity of the frame, based on a comparison of the integrity check and another integrity check, wherein the other integrity check is being based on at least the security key and one or more portions of the frame.

Clause 29: The method of Clause 28, further including responding to the frame based on the verification of the validity of the frame.

Clause 30: The method of any of Clauses 28-29, where: the PN includes only a portion of a complete packet number for the frame; another portion of the complete packet number is stored locally; and the method further includes updating the stored portion of the complete packet number based on an exchange of secure management frames.

Clause 31: The method of Clause 30, where: the complete packet number includes a global timestamp that is maintained by the wireless node or an access point (AP); when the global timestamp is maintained by the AP, the method further includes: obtaining the global timestamp from one or more protected Beacon frames; and when the global timestamp is maintained by the wireless node, the method further includes: outputting, for transmission, one or more protected Beacon frames indicating the global timestamp.

Clause 32: The method of any of Clauses 28-31, where the security key includes at least one of: an integrity group temporal key (IGTK), a pairwise temporal key (PTK), or a control integrity temporal key (CIGTK).

Clause 33: The method of any of Clauses 28-32, further including discarding the frame when the PN does not match an expected PN for the frame.

Clause 34: The method of any of Clauses 28-33, further including calculating the other integrity check.

Clause 35: The method of any of Clauses 28-34, where the PN includes at least one of: an integrity group temporal key (IGTK) packet number or an integrity pairwise temporal key (IPTK) packet number.

Clause 36: The method of any of Clauses 28-35, where: the frame includes a trigger frame including a user information list and the ID, the PN, and the integrity check after the user information list in the trigger frame.

Clause 37: The method of any of Clauses 28-36, where: the frame includes a trigger frame including a user information list including user information fields and the ID, the PN, and the integrity check in a subset of the user information fields.

Clause 38: The method of Clause 37, where: each of the user information fields of the subset includes an association identifier (AID) field having a reserved value associated with the integrity check; and the method further includes: obtaining the ID, the PN, and the integrity check from the user information fields of the subset.

Clause 39: The method of Clause 37, where: the integrity check is conveyed via eight octets or sixteen octets; when the integrity check is conveyed via eight octets, the subset consists of five user information fields; and when the integrity check is conveyed via sixteen octets, the subset consists of seven user information fields.

Clause 40: The method of any of Clauses 28-39, where: the integrity check is a portion of a complete integrity check for the frame; and another portion of the complete integrity check is known by the wireless node.

Clause 41: The method of any of Clauses 28-40, where: the frame includes a null data packet (NDP) announcement frame including station (STA) information fields and the ID, the PN, and the integrity check after the STA information fields.

Clause 42: The method of any of Clauses 28-41, where: the frame includes a null data packet (NDP) announcement frame including station (STA) information fields and the ID, the PN, and the integrity check in a subset of the STA information fields; and the method further includes: obtaining the ID, the PN, and the integrity check from the STA information fields of the subset.

Clause 43: The method of Clause 42, where: each STA information field of the subset includes an association identifier (AID) field having a reserved value associated with the integrity check; and the method further includes: obtaining the ID, the PN, and the integrity check from the STA information fields of the subset.

Clause 44: The method of Clause 42, where: the integrity check is conveyed via eight octets or sixteen octets; when the integrity check is conveyed via eight octets, the subset consists of seven STA information fields; and when the integrity check is conveyed via sixteen octets, the subset consists of ten STA information fields.

Clause 45: The method of any of Clauses 28-44, where: the frame includes a multi-station block acknowledgment (M-BA) frame including association identifier (AID) traffic identifier (TID) information fields and the ID, the PN, and the integrity check in a subset of the AID TID information fields; and the method further includes: obtaining the ID, the PN, and the integrity check from the AID TID information fields of the subset.

Clause 46: The method of Clause 45, where: each of the AID TID information fields of the subset includes an AID field having a reserved value associated with the integrity check.

Clause 47: The method of Clause 45, where: the frame includes padding after the subset; and a quantity of the padding is based on a number of symbols between the subset and an end of the frame.

Clause 48: The method of Clause 47, where the number of symbols is based on a period between the subset and an end of the frame; and the method further includes: requesting the period between the subset and an end of the frame.

Clause 49: The method of any of Clauses 28-48, where: the frame includes a block acknowledgment request (BAR) frame including BAR information fields and the ID, the PN, and the integrity check in a subset of the BAR information fields; and the method further includes: obtaining the ID, the PN, and the integrity check from the BAR information fields of the subset.

Clause 50: The method of Clause 49, where the BAR frame includes a multiple traffic identifier (multi-TID) BAR frame or a compressed BAR frame.

Clause 51: The method of Clause 49, where: each of the BAR information fields of the subset includes a Per traffic identifier (TID) info field having a first bit that is set.

Clause 52: The method of any of Clauses 28-51, where the integrity check includes a message integrity code (MIC).

Clause 53: The method of any of Clauses 28-52, wherein verifying the validity of the frame includes: decrypting one or more bits included in a medium access control (MAC) header of the frame, wherein verifying the validity of the frame comprises verifying the validity of the MAC header based on the decrypted one or more bits.

Clause 54: The method of Clause 53, wherein at least one of: the PN is a first PN associated with a MAC protocol data unit (MPDU) of the frame; or decrypting the one or more bits is based on a second PN associated with the MAC header and a second security key.

Clause 55: The method of Clause 54, wherein the frame further includes a header protection field comprising: an indication of the second PN; an ID of the second security key; and another integrity check based on the MAC header.

Clause 56: The method of any of Clauses 53-55, further including: outputting, for transmission, an indication that the wireless node supports MAC header encryption.

Clause 57: The method of any of Clauses 53-56, further including: obtaining an indication that another wireless node supports MAC header encryption, wherein the MAC header indicates a receiver address (RA) of the other wireless node.

Clause 58: An apparatus, including: a memory including executable instructions; and a processor configured to execute the executable instructions and cause the apparatus to perform a method in accordance with any one of Clauses 1-57.

Clause 59: An apparatus, including means for performing a method in accordance with any one of Clauses 1-57.

Clause 60: A non-transitory computer-readable medium including executable instructions that, when executed by a processor of an apparatus, cause the apparatus to perform a method in accordance with any one of Clauses 1-57.

Clause 61: A computer program product embodied on a computer-readable storage medium including code for performing a method in accordance with any one of Clauses 1-57.

Clause 62: A wireless node, including: at least one transceiver; a memory including instructions; and one or more processors configured to execute the instructions and cause the wireless node to: generate a frame including an identifier (ID) of a security key, a packet number (PN), and an integrity check, wherein: the integrity check is based on one or more portions of the frame, and the generation includes computing the integrity check based at least on the security key; and transmit, via the at least one transceiver, the frame.

Clause 63: A wireless node, comprising: at least one transceiver; a memory including instructions; and one or more processors configured to execute the instructions and cause the wireless node to: receive, via the at least one transceiver, a frame including an identifier (ID) of a security key, a packet number (PN), and an integrity check; and verify the validity of the frame, based on a comparison of the integrity check and another integrity check, wherein the other integrity check is based on at least the security key and one or more portions of the frame.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications, comprising:
at least one memory comprising instructions; and
one or more processors configured to execute the instructions and cause the apparatus to:
generate a frame comprising an identifier (ID) of a security key, a packet number (PN), and an integrity check, wherein:
the integrity check is based on one or more portions of the frame, and
the generation comprises computing the integrity check based at least on the security key; and
output, for transmission, the frame.

2. The apparatus of claim 1, wherein at least one of:
the PN comprises at least one of: an integrity group temporal key (IGTK) packet number or an integrity pairwise temporal key (IPTK) packet number;
the security key comprises at least one of: an IGTK, a pairwise temporal key (PTK), or a control integrity temporal key (CIGTK); or
the PN comprises only a portion of a complete packet number for the frame, another portion of the complete packet number is stored locally, and the one or more processors are configured to execute the instructions and cause the apparatus to update the stored portion of the complete packet number based on an exchange of secure management frames.

3. The apparatus of claim 1, wherein:
the frame comprises a trigger frame comprising a user information list comprising user information fields; and
the one or more processors are configured to execute the instructions and cause the apparatus to:
place the ID, the PN, and the integrity check after the user information list in the trigger frame or in a subset of the user information fields.

4. The apparatus of claim 3, wherein:
each of the user information fields of the subset comprises an association identifier (AID) field; and
the one or more processors are configured to execute the instructions and cause the apparatus to:
place the ID, the PN, and the integrity check in the subset of the user information fields; and
set the AID field, of each user information field in the subset, to a reserved value that indicates a presence of the integrity check.

5. The apparatus of claim 1, wherein:
the frame comprises a null data packet (NDP) announcement frame comprising station (STA) information fields; and
the one or more processors are configured to execute the instructions and cause the apparatus to:
place the ID, the PN, and the integrity check either:
after the STA information fields in the NDP announcement frame, or
in a subset of the STA information fields.

6. The apparatus of claim 5, wherein:
each STA information field comprises an association identifier (AID) field; and
the one or more processors are configured to execute the instructions and cause the apparatus to:
place the ID, the PN, and the integrity check in the subset of the STA information fields; and
set the AID field, of each STA information field in the subset, to a reserved value that indicates a presence of the integrity check.

7. The apparatus of claim 1, wherein:
the frame comprises a multi-station block acknowledgment (M-BA) frame comprising association identifier (AID) traffic identifier (TID) information fields; and
the one or more processors are configured to execute the instructions and cause the apparatus to:
place the ID, the PN, and the integrity check in a subset of the AID TID information fields.

8. The apparatus of claim 7, wherein:
each of the AID TID information fields of the subset comprises an AID field; and
the one or more processors are configured to execute the instructions and cause the apparatus to:
set the AID field, of each AID TID information field of the subset, to a reserved value that indicates a presence of the integrity check.

9. The apparatus of claim 7, wherein the one or more processors are configured to execute the instructions and further cause the apparatus to:
include padding in the frame after the subset, wherein a quantity of the padding is based on a number of symbols between the subset and an end of the frame.

10. The apparatus of claim 9, wherein the one or more processors are configured to execute the instructions and further cause the apparatus to:
obtain an indication of a requested period between the subset and the end of the frame; and
determine the number of symbols based on the requested period.

11. The apparatus of claim 1, wherein:
the frame comprises a block acknowledgment request (BAR) frame comprising BAR information fields; and
the one or more processors are configured to execute the instructions and cause the apparatus to:
place the ID, the PN, and the integrity check in a subset of the BAR information fields.

12. The apparatus of claim 11, wherein:
each of the BAR information fields of the subset comprises a Per traffic identifier (TID) info field; and
the one or more processors are configured to execute the instructions and cause the apparatus to:
set a first bit of each Per TID info field.

13. The apparatus of claim 1, wherein the one or more processors being configured to cause the apparatus to generate the frame comprises the one or more processors being configured to cause the apparatus to:
encrypt one or more bits included in a medium access control (MAC) header of the frame, wherein the one or more processors being configured to cause the apparatus to output the frame comprises the one or more processors being configured to cause the apparatus to output the MAC header including the encrypted one or more bits.

14. The apparatus of claim 13, wherein at least one of:
the PN is a first PN associated with a MAC protocol data unit (MPDU) of the frame; or
the one or more processors being configured to cause the apparatus to encrypt the one or more bits comprises the one or more processors being configured to cause the apparatus to encrypt the one or more bits based on a second PN associated with the MAC header and a second security key.

15. The apparatus of claim 14, wherein:
the one or more processors being configured to cause the apparatus to encrypt the one or more bits comprises the one or more processors being configured to cause the apparatus to encrypt the one or more bits based on the second PN associated with the MAC header and the second security key; and
the frame further comprises a header protection field comprising:
an indication of the second PN;
an ID of the second security key; and
another integrity check based on the MAC header.

16. The apparatus of claim 1, further comprising at least one transceiver configured to transmit the frame, wherein the apparatus is configured as a wireless node.

17. An apparatus for wireless communications, comprising:
at least one memory comprising instructions; and
one or more processors configured to execute the instructions and cause the apparatus to:
obtain a frame comprising an identifier (ID) of a security key, a packet number (PN), and an integrity check; and
verify validity of the frame, based on a comparison of the integrity check and another integrity check, wherein the other integrity check is being based on at least the security key and one or more portions of the frame.

18. The apparatus of claim 17, wherein:
the PN comprises only a portion of a complete packet number for the frame;
another portion of the complete packet number is stored locally; and
the one or more processors are configured to execute the instructions and cause the apparatus to:
update the stored portion of the complete packet number based on an exchange of secure management frames.

19. The apparatus of claim 17, wherein at least one of:
the security key comprises at least one of: an integrity group temporal key (IGTK), a pairwise temporal key (PTK), or a control integrity temporal key (CIGTK);
or the PN comprises at least one of: an IGTK packet number or an integrity pairwise temporal key (IPTK) packet number.

20. The apparatus of claim 17, wherein:
the frame comprises a null data packet (NDP) announcement frame comprising station (STA) information fields and the ID, the PN, and the integrity check; and
the ID, the PN, and the integrity check are located:
after the STA information fields, or
in a subset of the STA information fields; and
the one or more processors are configured to execute the instructions and cause the apparatus to:
obtain the ID, the PN, and the integrity check from the NDP announcement frame.

21. The apparatus of claim 17, wherein:
the frame comprises a multi-station block acknowledgment (M-BA) frame comprising association identifier (AID) traffic identifier (TID) information fields and the ID, the PN, and the integrity check in a subset of the AID TID information fields; and
the one or more processors are configured to execute the instructions and cause the apparatus to:
obtain the ID, the PN, and the integrity check from the AID TID information fields of the subset.

22. The apparatus of claim 21, wherein:
each of the AID TID information fields of the subset comprises an AID field having a reserved value associated with the integrity check.

23. The apparatus of claim 21, wherein:
the frame includes padding after the subset; and
a quantity of the padding is based on a number of symbols between the subset and an end of the frame.

24. The apparatus of claim 23, wherein:
the number of symbols is based on a period between the subset and an end of the frame; and
the one or more processors are configured to execute the instructions and further cause the apparatus to:
request the period between the subset and the end of the frame.

25. The apparatus of claim 17, wherein:
the frame comprises a block acknowledgment request (BAR) frame comprising BAR information fields and the ID, the PN, and the integrity check in a subset of the BAR information fields; and
the one or more processors are configured to execute the instructions and cause the apparatus to:
obtain the ID, the PN, and the integrity check from the BAR information fields of the subset.

26. The apparatus of claim 17, wherein the one or more processors being configured to cause the apparatus to verify the validity of the frame comprises the one or more processors being configured to cause the apparatus to:
decrypt one or more bits included in a medium access control (MAC) header of the frame, wherein the one or more processors being configured to cause the apparatus to verify the validity of the frame comprises the one or more processors being configured to cause the apparatus to verify the validity of the MAC header based on the decrypted one or more bits.

27. The apparatus of claim 26, wherein at least one of:
the PN is a first PN associated with a MAC protocol data unit (MPDU) of the frame; or
the one or more processors being configured to cause the apparatus to decrypt the one or more bits comprises the one or more processors being configured to cause the apparatus to decrypt the one or more bits based on a second PN associated with the MAC header and a second security key.

28. The apparatus of claim 27, wherein:
the one or more processors being configured to cause the apparatus to decrypt the one or more bits comprises the one or more processors being configured to cause the apparatus to decrypt the one or more bits based on the second PN associated with the MAC header and the second security key; and
the frame further comprises a header protection field comprising:
an indication of the second PN;
an ID of the second security key; and
another integrity check based on the MAC header.

29. The apparatus of claim 17, further comprising at least one transceiver configured to receive the frame, wherein the apparatus is configured as a wireless node.

30. A method for wireless communications at a wireless node, comprising:
obtaining a frame including an identifier (ID) of a security key, a packet number (PN), and an integrity check; and
verifying validity of the frame, based on a comparison of the integrity check and another integrity check, wherein the other integrity check is being based on at least the security key and one or more portions of the frame.
